(19) United States
(12) Patent Application Publication
(10) Pub. No.: US 2025/0155602 A1
(43) Pub. Date: May 15, 2025

(54) PLANAR SENSOR FOR DETECTING AN INCIDENT LIGHT SIGNAL

(71) Applicant: Alfred WRANESCHITZ, Perchtoldsdorf (AT)

(72) Inventor: Alfred WRANESCHITZ, Perchtoldsdorf (AT)

(21) Appl. No.: 18/833,642

(22) PCT Filed: Jan. 26, 2022
(86) PCT No.: PCT/EP2022/051818

§ 371 Date: Jul. 26, 2024

(51) Int. Cl. G01V 8/10; F41A 33/02; F41G 3/26; G02B 6/04; G02B 6/36

(52) U.S. Cl. CPC G01V 8/10; F41A 33/02; F41G 3/2655; G02B 6/04; G02B 6/3664

(57) ABSTRACT

The invention relates to a planar sensor (1), comprising: at least one light guide (2) which has, along its longitudinal extension and on the side thereof intended for light entry, discontinuities (9) in order to allow detection or entry of a light signal (8); and a support element (4) which supports the light guide (2) on one side, preferably such the that discontinuities (9) of the light guide (2) are oriented away from the support element (4).

### TECHNICAL FIELD

The invention relates to a planar sensor for detecting an incident light signal.

### Background

A sensor for detecting an incident light signal is used, for example, in military exercises to detect simulated weaponry hits. For example, soldiers wear special vests equipped with the sensors for this reason. In addition to attaching light-signal transmitters to service weapons, laser light-signal transmitters are also used here, which are visually reminiscent of handguns and are designed to emit a laser signal. If the laser signal reaches the sensor, this is detected, and the soldier wearing the vest equipped with the sensor is deemed to have been hit. Such a vest is known from the EP0067654A2, for example. Here, a plurality of point-shaped light sensors are provided as sensors on the surface of the vest, which are placed across the vest in a distributed manner. Here, however, there are a plurality of large blind zones between the point-shaped light sensors, in which incident laser signals, i.e., “hits”, cannot be detected. To ensure an acceptable coverage of the vest surface, a plurality of these point-shaped light sensors must be provided. The vest obtained in this manner is relatively heavy and not very flexible. The special training requirements of security forces that can be derived from an increasing threat situation from assailants and hostage-taking (here, for example, it is a matter of a concealed field of fire with a maximum area of 10-15% of the hostage-taker) is also not possible with existing training systems.

Current simulation systems on the market (duel simulation/firearms simulation) are essentially limited to point-specific hit zones with point-specific static sensors with reflectors or focus-magnifier technology, which are located on a carrier in the form of non-deformable sensor housings.

Due to the point-shaped, limited evaluation areas of the sensors, it is only possible to a to correctly assign a hit to certain body regions during a combat or deployment simulation limited extent or not at all in order to derive conclusions about the degree of injury that has occurred.

The object of the invention is therefore to provide a sensor in which the disadvantages discussed at the outset are overcome and the use of which is scalable.

### SUMMARY OF THE INVENTION

This task is solved by means of a planar sensor according to claim 1. Therefore, the object of the invention entails a planar sensor comprising: at least one light guide which comprises discontinuities along its longitudinal extension on the side thereof intended for light entry in order to allow detection or entry of a light signal and a support element which supports the light guide on one side, preferably in such a way that the discontinuities of the light guide are oriented away from the support element.

The task is furthermore solved by means of means of a manufacturing method according to claim 7. The object of the invention therefore also entails a manufacturing method for manufacturing a planar sensor, wherein at least one light guide is fixed on one side of a support element, preferably fixed in a substance-to-substance manner, being particularly preferred, glued.

The task is furthermore solved by means a planar-sensor module according to claim 12. The object of the invention therefore also entails a planar-sensor module comprising a planar sensor according to the invention and a reception detector coupled to the planar sensor, which is designed to convert a light signal that has entered the planar sensor into an analog or digital electrical reception signal and emit it.

The task is furthermore solved by means of a planar-sensor group according to claim 14. The object of the invention therefore also entails a planar-sensor group, which comprises: at least one planar-sensor module according to the invention, and a processing module coupled with at least one planar-sensor module, which is designed to process the reception signal of at least one planar-sensor module, preferably to capture the data content thereby represented.

The problem is furthermore solved by means of a system according to claim 17. The object of the invention therefore entails a system comprising: at least one planar-sensor group according to the invention, and a central module coupled with at least one planar-sensor group.

The problem is furthermore solved by means of a combat or sports suit or gaming suit or tracksuit according to claim 24. The object of the invention therefore also entails a combat or sports or gaming or tracksuit which comprises at least one planar-sensor module according to the invention, preferably at least one planar-sensor group according to the invention, being particularly preferred, a system according to the invention.

The problem is furthermore solved by means of a device or component cover according to claim 25. The object of the invention therefore also entails a device or component cover which comprises at least one planar-sensor module according to the invention, preferably at least one planar-sensor group according to the invention, being particularly preferred, a system according to the invention.

The light guide used according to the invention is largely a transparent component, such as a fiber, or a tubular or rod-like structure that transports light, i.e., thereby guiding it. Preferably, the light guides are light guides known in communications engineering as fiber optic cables. Polymer optical fibers (POFs for short) can be preferred as light guides, because POFs can be processed better than comparable fiber optic light guides in the context of this invention.

As discussed in the context of the manufacturing method, the planar sensor can be made of a single light guide or a plurality of light guides. What is disclosed exemplarily for a plurality of light guides in terms of processing and structure can of course also be used in relation to only a single light guide and vice versa.

The discontinuities intended for the entry of the light signal into the light guide, which act as light entry points, can be introduced into the light guide by deliberately damaging the surface of the light guide. Of course, the discontinuities can also be prefabricated on the light guide, particularly in a part of the circumference intended for light entry. This can be implemented, for example, by applying the discontinuities to the light guide while it is placed for contacting the support element. This upstream processing step of the light guide also allows the light guide to be attached to the support element in the correct orientation. Of course, the light guide can also be provided with discontinuities on one side during production, but this requires a careful approach with regard to the correct attachment to the support element. However, the processing step for the subsequent introduction of the discontinuities can then be favorably omitted.

The support element that supports the light guide gives structure to the planar sensor and holds the light guide in position. The support element is also designed in such a way that it makes the discontinuities accessible for light entry. For this purpose, the support element can be transparent and the discontinuities of the light guide can be oriented towards the support element. In this case, light signals can enter the light guide through the support element via the discontinuities. Preferably, the discontinuities of the light guide are oriented away from the support element. In this case, the support element can be transparent or opaque or mirrored towards the light guide. As viewed in the direction of light entry, the support element in this configuration is located behind the light-guide layer.

In the manufacturing method, the light guide is essentially fixed exclusively—i.e., only-on one side of the support element. “On one side” here means that the light guide follows the contour or surface of the support element as far as possible, i.e., does not alternately plunge into or emerge from it for example, as would be the case with a woven structure. This measure makes it possible to provide a planar sensor without blind zones, because the light guide is guided in a shadow-free manner. When fixing, the light guide is inserted into the support element or applied to the support element, or the support element is applied to the light guide. If it is a liquid or viscous support element at the time contacting between the support element and the light guide occurs, at least one light guide can be inserted into this support element. If it is a liquid, viscous or solid support element at this time, for example an adhesive strip, the light guide can be applied to the support element. Conversely, the light guide (liquid or solid) can of course also be applied to the support element. In all cases, the light guide or light guides are arranged in one position, i.e., the aforementioned light-guide layer, or fixed in this light-guide layer by the support element.

The reception detector of the planar-sensor module allows for the detection of an impact of a light signal on the planar sensor so that a reaction to the resulting analog or digital electrical reception signal can subsequently take place via further signal processing measures. The light signal can be detected electronically or also chemically with an opto-chemical or photo-chemical detector.

Hereby, the planar-sensor module is the smallest assembly. Here, a planar sensor is always coupled with one or two reception detectors. In the embodiment type with a single reception detector, the light signal entering the light guide(s) is only detected or tapped on one side at one end of the light guide(s). In the embodiment type with two reception detectors, the light signal entering the light guide(s) is detected or tapped on both sides at both ends of the light guide with one of the reception detectors each, which can be favorable in terms of signal yield.

The next largest assembly is formed by the planar-sensor group. Here, the processing module is coupled with at least one planar-sensor module. However, for structural reasons as well as efficiency, it is preferable to combine a plurality of planar-sensor modules with one processing module. They can be efficiently combined as clusters of planar sensors, particularly if they are also spatially grouped, and be electronically evaluated in a decentralized manner separated from any other existing planar-sensor groups (other clusters) with a single processing module respectively. The evaluation results obtained in this way in a decentralized manner can then be passed on without any problems, possibly even via conventional or also standardized transmission methods, or retrieved from the processing modules, for example, made accessible to central processing.

The use of a combat or sports or gaming or tracksuit that comprises at least one planar-sensor module according to the invention allows military exercises or police exercises to be carried out or even athletic exercises or recreational exercises or also training exercises for private security personnel, in which the detection of a simulated projectile hit by detecting a light beam entering the planar sensor is possible without the problem of blind zones within the of the planar sensor. Because the planar sensors according to the invention, with which the suit is equipped, do not comprise blind zones in the desired detection area, it can be avoided that hits on the body of the person are mistakenly not detected. The suit is worn by one person during these exercises and can cover a large part of the body surface with the planar sensors so that “light-signal hits” can be realistically detected almost over the entire surface. However, the planar sensors can also be distributed in such a way that only selective areas are covered.

Likewise, for the first time, the device or component cover allows for the detection of hits on mobile as well as stationary devices, such as vehicles, weapon or weapon systems, in particular artillery equipment, computer systems, or also on building or plant components, such as building walls, bridges (elements) or bunker systems, which are used in this type of exercise.

This allows a more realistic simulation with the inclusion of all simulation-relevant devices and thus leads to a better training result.

The evaluation of the detected “light-signal hits” can be carried out in the central module of the system, where all signals from the involved processing modules converge. The raw data as well as the preprocessed acquisition data can be transmitted to a central exercise monitoring server, where they can then be evaluated for the evaluation of the exercise sequence as well as for the provision of the exercise results.

Preference is given to a light signal, in particular encoded, which hits a planar sensor used in the system, which is converted into an electrical signal by the reception detector and the processing module records the data content or information transported with the encoding, which is then electronically passed on to the central module. In the central module or also already in the processing module, this data content can now be used to trigger an action. This action can include, in particular, providing the wearer of the suit with feedback on the fact that the light signal has hit, as will be discussed in detail below, and/or sending out a signal, in particular a control signal to control a system component.

In general, therefore, it can be stated that the measures according to the invention are accompanied by the advantage that a realistic simulation of a military or police operation using firearms is possible, in which hits are detected safely and precisely without errors occurring in the detection of hits due to blind zones, because the planar sensor is designed as such over the entire area. In addition, precise delimitation of hit zones, for example to a few cm2, and evaluation of the hit effect in relation to these hit zones is possible. Particularly noteworthy is the fact that the measures discussed allow the implementation of a flexible planar sensor, i.e., a flexible, elastic planar sensor that can easily adapt its surface shape to the forces or the conditions in which it is used without being damaged. Due to these properties, the planar sensor can be easily incorporated into or attached to an article of clothing without hindering/restricting the wearer's ability to move.

Further, particularly favorable embodiments and further embodiments of the invention result from the dependent claims as well as the following description.

It has therefore proved to be particularly favorable that the system is designed for autonomous processing of data content acquired by the processing module (20) of the planar-sensor group (19) and for generating a control signal. Furthermore, it can also be designed to transmit the data content acquired with the help of the processing module of the planar-sensor group, preferably via radio communication, if there is a radio-communication connection. The ability of autonomous processing allows reliable work even in the absence of a radio-communication connection.

This control signal can then control a unit or a device that releases or emits a haptic or mechanical, optical or acoustic emission signal that can be perceived by the user so that a user can perceive the imperceptible as well as the silent impact of the light signal in the first place. The emission signal therefore has the function of a feedback signal for the user or the exercise participant.

However, the control signal can also be sent to a device in the vicinity of the exercise participant, wherein this control signal informs the device that a hit or a light signal has been detected on the suit equipped with the planar sensors.

For example, the device can be a signal-emission device of a first exercise participant. The signal-emission device is designed to emit the light signal that can be detected with the help of the planar sensor and is used for shooting simulation when firing a weapon of the first exercise participant. Subsequently, in the signal processing of the suit of a second exercise participant in which the emitted light signal hits, it can be decided, for example, depending on at least one defined criterion, whether such a hit would incapacitate this second exercise participant. If this is the case, for example, the signal-emission device of this exercise participant can be blocked so that he cannot emit any further light signals, i.e., simulated shots.

Experience has shown that the best training effects can be expected if the weapon system assigned to the respective exercise participant, such as one's own service weapon, such as a pistol or rifle or other tactical weapons, is practiced.

Therefore, it is particularly favorable if the system comprises the signal-emission device that can be attached to a weapon, particularly a firearm, preferably without obstructing the firing of the weapon, and the signal-emission device is designed to emit the light signal corresponding to the firing of the weapon. For this purpose, the signal-emission device is preferably designed to be mounted on a mounting rail provided on the weapon, in particular, on a Picatinny rail. The signal-emission device is therefore preferably designed as an attachment for a weapon. This allows blanks to be used in the exercise, which contributes to a more realistic simulation of an operation.

In order to be able to accurately detect the firing of such a weapon and thus also to be able to emit the corresponding light signal at the right time, it has proven to be particularly favorable the that signal-emission device comprises an acceleration sensor to detect acceleration, which is caused, for example, by firing of a blank bullet, and preferably also an acoustic sensor for detecting a sound event, which is produced when the blank bullet is fired, and that the signal-emission device, taking into account an acceleration detected by the acceleration sensor, preferably taking into account the sound event detected, is designed to detect the firing of a weapon to which the signal-emission device is attached, and that the signal-emission device is designed to automatically emit the light signal as a result of detecting the firing of the weapon.

This not only achieves the time-synchronous emission of the light signal with the firing of the weapon, but also the directionally correct emission of the light signal, because the direction of the light beam to be emitted usually coincides essentially with the direction of the projectile to be fired under real conditions.

If an exercise participant is hit by an emitted light signal, it can be favorable if the signal-emission device, which in the present context is assigned to the exercise participant hit, is designed to receive the control signal and to influence its range of functions depending on the control signal.

Being particularly preferred, the ability to emit the light signal can be influenced by the ability to emit the light signal. This can include, for example, the complete prevention of the emitting of light signals or also only temporary availability to transmit the light signals. In this way, the effect of a projectile hit on the exercise participant can be realistically simulated, wherein this realistically assumed effect is transferred to the weapon system assigned to the exercise participant and the realistic operational readiness of the exercise participant is limited by availability control of the weapon system.

In an exercise scenario, the preceding characteristic-related discussion can be summarized as follows. If a bullet, or in the context of such an exercise, in particular, a blank bullet, is fired, there is a characteristic movement or acceleration of the weapon. This acceleration can preferably be easily detected by means of the acceleration sensor and processed or evaluated by means of a signal-emission processing module. Furthermore, an acoustic sound event can be detected, which verifies the firing of the bullet.

Also, the light signal can only be emitted as a result of a detection of the acoustic sound event. However, there is a risk that the acoustic signal will be emitted by a weapon positioned near the exercise participant that is not assigned to the signal-emission device of the exercise participant in question, which would lead to error detection.

The signal-emission device therefore emits a light signal when a firing of a (blank) bullet is detected. Under certain circumstances, however, the emission of the light signal can also be prevented or restricted, for example if the exercise participant who wants to fire a shot is already considered to have been eliminated or injured. For this purpose, the signal-emission device can comprise a radio-communication stage or be coupled with a radio-communication stage and the central module can also comprise a radio-communication stage or be coupled with a radio-communication stage. If an exercise participant is hit by the light signal of another exercise participant on a planar sensor, this hit is communicated to the central module. In this case, the coded light signal contains data regarding the signal-emission device emitting the light signal, such as the caliber of the weapon that is simulated there for example. Depending on the location where the light signal was detected, i.e., the region of the body, and the data transmitted using the light signal, such as the data regarding the caliber of the weapon for example, the central module (of the hit exercise participant) evaluates the severity of the simulated injury and sends a corresponding control signal regarding the ability to fire further shots to the signal-emission device of the hit exercise participant. If, for example, this is a hit that would immediately lead to death in an actual combat scenario, the exercise participant is considered to have been eliminated and the control signal received by the signal-emission device prevents further emitting of light signals. The exercise participant can then still physically participate in the exercise, even fire blank bullets, but these do not cause any hits on opponents, because the emission of the light signal is prevented. This means that any erroneous action by a combat participant who has already been eliminated can be prevented in real time.

However, if it is a hit that would not immediately kill the exercise participant in an actual combat scenario but would at least render him/her incapacitated in the temporal context, the control signal can contain time control data that instructs the light emitting device to allow the emission of light signals within a certain time after the hit before the emission of light signals is finally stopped. This means that it can be simulated that an exercise participant in the exercise can continue to defend himself for some time after such a hit, before the injury caused by the hit would realistically prevent further action with the weapon. Of course, the central module also takes into account other hits, which can shorten the remaining period of operational capability.

Furthermore, the control signal can also be transmitted to a server, which centrally monitors and, where applicable, coordinates the entire exercise process, and/or to devices for providing feedback to the exercise participant, as discussed at the appropriate point.

It should be mentioned that in addition to shot detection by recording acceleration, other triggers can be used to emit a light signal by the signal-emission device, which can occur alone or in combination and are discussed below.

If the signal-emission device is designed to be attached to a handgun, the signal-emission device can comprise a trigger-check stage that checks whether the trigger of the handgun is being pulled and, if the trigger is pulled, emit a light signal. In particular, it is favorable if the trigger-check stage is designed to be tunable to the trigger of the handgun. In this case, the signal-emission device can be set to emit the signal when the trigger of the handgun is moved over the pressure point of the trigger. As a result, the feel of the handgun in the simulation or exercise is largely the same as in a real operation. Equivalent to the trigger, the hammer or the or other moving components of the handgun can also be checked for example.

This can be done mechanically, which can be easily implemented, for example, by means of a button. However, this is problematic in terms of safety when using a real weapon, for example with blank bullets, because after the weapon has been used during the exercise, the weapon must be checked and maintained before it can be used as a service weapon again. Therefore, the trigger or launch is preferably checked in such a way that the check is free of mechanical contact with the firing mechanism of the weapon. It is therefore favorable if a trigger inspection stage is provided that comprises an optical sensor, preferably a camera, which is designed to detect trigger actuation. A particularly good check can be achieved if a shooting review stage, as discussed below, is provided.

If the signal-emission device is still designed in such a way that the handgun can fire blanks without hindrance, a firing inspection stage can be provided to check whether a blank bullet has been fired. This detection can be done by means of acceleration sensors and/or acoustic sensors, as discussed.

To simulate explosions or weapons with a large dispersion, for example, signal-emission devices can be provided that emit the light signal in a divergent beam of radiation, or even signal-emission devices that emit a diffuse light signal.

In most cases, however, it is favorable that the signal-emission device, similar to a handgun, comprises a low dispersion level. Therefore, the signal-emission device is preferably designed to emit a laser light signal.

The light signal is preferably a light signal whose wavelength is outside the wavelength range visible to humans.

In accordance with one aspect of the invention, it is favorable that an encoded light signal is used as a light signal. This contains information that it transmits to the planar sensor or the planar-sensor module by means of the coding. The coding can be implemented, for example, by means of a light pulse sequence over time. The information transmitted in this way preferably includes a weapon ID or a signal-emission device ID, which includes an identification of the (handgun) weapon and/or the signal-emission device, and/or a shooter ID, which identifies the shooter, i.e., the exercise participant. Furthermore, the information can include which type of weapon it is or which type of weapon is simulated and which caliber is simulated. In addition, other information can be included, such as the time when the signal was emitted. The coded light signal can also be used to transmit geographical coordinates to define the location of the exercise participant who caused the emission of the 1 light signal. This also indicates the distance between the two exercise participants (i.e., the first exercise participant who causes the light signal to be emitted and the second exercise participant who is hit by the light signal), which also has an influence on the realistically expected effect of a projectile hit. In general, therefore, the system or its central module is designed to autonomously process the data content acquired by means of the processing stage of the planar-sensor group in order to determine a realistically expected effect of the event represented or simulated by the light signal.

If the light signal is detected by a planar-sensor module or a planar-sensor group, the data transmitted with the encoded light signal can be compared with a (medical) database and a realistic injury pattern corresponding to the detected hit can be defined or retrieved. The medical database provides the usual injury patterns depending on the bullet point, the caliber, the distance between the exercise participants, etc., and thus allows a realistic battle simulation without actually endangering the exercise participants. The exact calculation of the degree of injury by a medical database enables the automatic integration of the supply line, particularly the complete one, into the exercise. Rescue workers such as paramedics and field doctors as well as the care provided by field hospitals through to medication and the consumption of bandages can be simulated exactly.

On the basis of the autonomously determined, realistically expected effect of the event represented or simulated by the light signal, the system automatically provides or transmits all data relevant to parts of the supply line or the entire supply line.

In particular, taking into account the distance between the exercise participants, it can also be ensured that detected light signals are disregarded if the distance between the exercise participants exceeds the operational range of the weapon to be used. To take this aspect into account, all participants comprise, for example, a GPS receiver to record their position outside buildings. For position detection inside buildings, other position detection technologies can be used, such as: “Ultra-Wideband-Technology”, or UWB technology for short, which is used for precise indoor position detection. These different technologies can also be used in combination to achieve comprehensive position detection with the required accuracy.

Details of the planar sensor are discussed below.

In order for the light signal to enter the light guides of the planar sensor, the discontinuities are inserted into the light guides. By fixing the light guides in advance on one side of the support element, it is now possible for the first time to introduce these discontinuities specifically on one side of the light guide intended for light entry. The light guide or light guides, i.e., the light-guide sections, are positioned in a layer in the planar sensor so that the light guides or light-guide sections form a light-guide layer.

In accordance with a further aspect of the invention, the light guide along the side of the light guide not intended for light entry is essentially free of defects. As a result, the light or the light signal on the intended side can enter the sensor along the longitudinal extension of the light guide, while the other side comprises the typical refraction or reflection behavior for the light signal propagating in the light guide along its longitudinal extension so that the light signal is held in the light guide and passed on to the end of the light guide. This means that as far as possible, no light is emitted on the side of the planar sensor that is not intended for this purpose. Thus, a light signal impinging on the light sensor at a relatively weak intensity can also be detected. Such a situation can exist if the light signal is scattered or attenuated, for example, by high humidity or dust, or comes from a great distance.

In the case of light guides, it has proven to be favorable if the discontinuities are inserted along about half the circumference of the cross-section and this part of the cross-section is oriented in the planar sensor for the incidence of light. This ensures both good light capture or light absorption as well as good light conduction. Of course, the circumferential segment that comprises the discontinuities can also be smaller, for example, a third or even only a quarter.

It is also favorable that the light-guide sections of a light guide or a plurality of light guides are positioned directly next to each other on the support element. This allows the detection area provided on the support element to be used to the maximum, and this area can therefore be used free of blind zones. In particular, the light guides are placed in the immediate vicinity of each other without any web. This makes the planar sensor not only particularly flat but can also be designed very flexibly in terms of its flat shape.

The light guide can be fixed in a positive-locking, nonpositive-locking or in a substance-to-substance manner. For example, the support element can comprise grooves into which the light guide is placed and fixed in a positive-locking or nonpositive-locking manner.

It has proven to be particularly favorable that at least one light guide is bonded to the support element in a substance-to-substance manner.

To achieve a substance-to-substance bond or fixation, the support element can comprise an adhesive layer, or at the time of placement, the support element can comprise sticky properties or even be designed as a glue. The support element can also be melted onto the light guide. For this purpose, the material or the melting behavior, in particular the melting point of the support element, in particular at the contact parts with the light guide, must be selected in such a way that the support element is melted, but the light guide is retained undamaged. The light guide is then connected to the support element by means of melting the support element in a solidifying manner.

The support element can generally be designed as a film. According to a preferred aspect of the invention, the support element is designed as an adhesive film.

Furthermore, at least one essentially transparent protective layer can be provided to protect the light guide of the planar sensor, in particular, from mechanical loads. Such a protective layer can be implemented as part of the planar sensor itself. However, a protective layer can also be applied to the planar-sensor module.

Furthermore, it has proven to be favorable if the planar sensor comprises a diffuser layer, particularly microlenses. This measure is preferably planned upstream in the direction of light entry, i.e., in the direction of light entry. The diffuser layer is designed to scatter light. This diffuser layer is to be attached to the side of the light guide that comprises the discontinuities. The diffuser layer distributes incident light, particularly by means of microlenses or “microlenses”, which are distributed on the diffuser layer, on a plurality of light guides or light-guide sections. This makes it possible to successfully also direct very shallow light incident signals to the discontinuities and thus into the light guide. Furthermore, this measure increases the reliability of the planar sensor. If, for example, a light guide has been damaged by mechanical overload, the diffuser layer directs the incident light signals, which would only hit one light guide without the diffuser layer, to the light guides next to it so that they can safely transmit the light signal. The diffuser layer therefore generates reliable light signal transmission through redundancy in the light signal entry yield.

The entire diffuser layer can be made of a material that splits incident light. However, as mentioned, the diffuser layer can also contain a plurality of microlenses or microlenses. “Microlenses” which, due to their shape and/or material, divide the incident light signal into a plurality of light guides or light-guide sections.

The diffuser layer, as well as the previously mentioned protective layer, can also be applied to the planar-sensor module.

Preferably, the diffuser layer also directly forms the protective layer.

Furthermore, the planar sensor can comprise a semipermeable mirror layer, which on the one hand allows incident light to penetrate as completely as possible and on the other hand prevents re-exit via reflection. The semipermeable mirror layer is preferably located between the diffusion layer and the light-guide layer. Furthermore, the planar sensor can comprise a reflector layer that is designed to reflect light. The reflector layer is preferably located on the side of the light guide that comprises no discontinuities, with the reflecting surface oriented towards the light guide. This makes it possible to reflect incident light that penetrates up to this reflector layer from there and, in interaction with the mirror layer, to make this light component available again for entry into the light-guide layer. This allows more light to be absorbed, which has a positive effect on the detection behavior for light signals at a relatively low intensity. As mentioned, the support element can be designed to be mirror-like so that the support element itself can comprise the reflector layer.

In accordance with a further aspect of the invention, the planar sensor can also comprise a signal-emission layer which is designed to emit an emission signal that can be optically generated or mechanically generated.

Such a mechanically generable output signal can be emitted in particular by vibration motors, which are integrated into the signal-emission layer for this purpose. Such a vibration motor, also known as the “IIVibra motor”, is now used in mobile phones, for example, and is available in very flat embodiments at low cost. By using such flat vibration motors, the flat structure and the associated advantages of the planar sensor are preserved. The signal-emission layer can comprise one or a plurality of such vibration motors. The arrangement of the signal-emission layer is preferred to the side of the planar sensor facing away from the light entry. The vibration motor can be positioned there or the vibration motors can preferably be positioned evenly distributed. Electrical cables that run in this signal-emission layer and are led out of the planar sensor at their edge are used to control vibration for the purpose of generating vibration as vibration feedback for a hit.

The signal-emission layer can also be designed for the optical emission of an emission signal. For this purpose, the signal-emission layer itself can comprise light guides that have discontinuities, for example. In this case, however, a light is introduced into these additional light guides of the signal-emission layer at the ends of the light guides in order to guide it to the discontinuities where the light can escape. Thus, the signal-emission layer can glow in color, for example, to make visual feedback on a hit recognizable to indicate the affiliation of a team or to indicate the activity of the system or the planar-sensor group. Such a signal-emission layer can be located, for example, under the light-guide layer intended for light signal detection, i.e., on the side of the light-guide layer that is not intended for light signal entry.

Furthermore, the signal-emission layer can be equipped with one or a plurality of RGB LED(s) (RGB LED stands for 11 Red Green Blue Light Emitting Diode, i.e., an LED with which light can be generated based on the three primary colors red, green and blue), wherein the RGB LEDs can be located particularly at the level of the vibra motors. If the reflector layer is present, in the area of the RGB LED(s), a freeing (or a removal) of the reflector layer above is provided, which allows the light to be illuminated by the light-guide layer above. The optical emission signal is then visible through the light-guide layer intended for light detection. Optionally, the signal-emission layer can only be equipped with RGB LEDs.

However, the signal-emission layer intended for the optical emission of the emission signal can also be located, for example, at the edge of the planar sensor and, for example, border around it or surround it in a frame-like manner on the edge side so that an incident light signal within the frame can enter the light-guide layer intended for the detection of light signals without being hindered. The framing signal-emission layer can emit light in an unhindered manner even through the light-guide layer, because the light pus layer does not cover it or only covers it slightly, or it can also radiate its light through the light-guide layer or illuminate the light-guide layer inwards from the edge of the planar sensor.

The light-guide layer intended for detecting the light signal can also form the signal-emission layer. For this purpose, a light source can be provided in addition to the reception detector or also be integrated into the reception detector, which feeds an optical emission signal into at least one light guide of the planar sensor so that it lights up in the corresponding light color.

Of course, a plurality of signal-emission layers, i.e., one for an optical and one for a mechanical emission signal, or a combined signal-emission layer for emitting an optical and a mechanical emission signal, can also be provided.

As can already be seen, the planar sensor comprises a sandwich structure made up of a plurality of layers, each of which provides a different function.

In general, the planar sensor offers the advantage that it can be produced cost-effectively in large quantities and can be automated in accordance with the manufacturing method discussed and can be used as flexibly as possible in a wide variety of applications. Details of this manufacturing method are discussed below.

It has proven to be particularly favorable if at least one light guide is applied to a positioning device, preferably being wound onto it. This enables rapid and, above all, error-resistant positioning.

The application can be done in different ways. For example, a single light guide can be applied or a plurality of light guides can be applied to each other at the same time. For example, the application of a plurality of light guides can be carried out in such a way that they are placed close together on the positioning device automatically.

For example, a CNC-controlled machine can apply a light guide to the positioning device. Here, for example, the light guide can be applied in a spiral shape to a flat support element so that the light guide can be optically coupled at one or both ends. In this minimal configuration, the planar sensor can also comprise only a single continuous light guide.

Similarly, winding a single or a plurality of parallel light guides onto the positioning device along the perimeter of the positioning device allows for directly adjacent light-guide sections to be obtained so that no blind zones can be created in-between. In particular, this variant does not have to take into account the usually limited bending radius of the light guides, because they are essentially only slightly curved which along the positioning device, comprises a sufficiently large diameter. If a plurality of light guides are wound on simultaneously, they will come to rest in parallel to each other by the respective thickness of the other light guide.

The support element can be applied to the positioning device in advance so that the light guide is fixed to the support element simultaneously as it is applied to the positioning device. For this purpose, it is preferable to place the support element on the positioning device before placing the light guide so that the side of the support element on which the light guide is to be placed is directed away from the positioning device. If, for example, the support element is formed as a viscous adhesive layer at this point in the manufacturing method, a separating layer and/or an adhesive layer can also be applied between the positioning device and the support element, which ensures that the support element can be detached from the positioning device again after the light guide has been applied, or that the support element remains on the positioning device during the winding process.

It has proven to be particularly favorable if the light guide is applied to a positioning device, preferably wound on, before the light guide is fixed on one side of the support element, preferably fixed in a substance-to-substance manner, and being particularly preferred, if it is preferably glued on. Preferably, the support element is designed as an adhesive strip or adhesive film so that the support element can be applied to the parallel light-guide sections after the winding of at least one light guide on the positioning device so that the light guides are fixed to one adhesive side of the support element. However, the support element can also be designed as a film that can be melted on, which is attached to the coiled light-guide sections in an equivalent way to the adhesive film and then heated so that incomplete melting of the film creates a substance-to-substance bond between the film and at least one light guide when the film cools. As mentioned, the melting point must be selected in such a way that the light guide remains undamaged by the heat introduced. A liquid or viscous glue can also be applied to the light-guide sections as a support element. This means that the support element is the liquid or viscous glue that solidifies on one side of the light guide. Preferably, the glue is applied and solidified on the side that is not intended to comprise discontinuities.

In general, it is favorable in the manufacturing method that at least one light guide comprises at least one free, i.e., not fixed, light-guide segment so that the light signal guided through the light guide can be picked up away from the fixed area of the light guide. For this purpose, the at least one light guide is only fixed over part of its length on one side of the support element. This allows one or a plurality of sufficiently long free ends to be created so that a coupling with the reception detector is unproblematic.

Winding the light guide onto the positioning device can be done, for example, as follows: The light guide is located in the initial state on a storage coil. From the storage coil, the light guide is fed to a winding device. This winding device rotates the positioning device so that the rotating positioning device pulls the light guide attached to it from the storage coil and positions it along its circumference. For this purpose, the winding device can also comprise a light-guide guide that guides the light-guide section that is currently being pulled onto the positioning device directly to the light-guide section that is already parallel to it.

For this purpose, the positioning device can be essentially rotationally symmetrical, in particular cylindrical, such as a tube-like cylinder or a rod-like cylinder for example. Such a tubular or cylindrical positioning device can be used to produce curved planar sensors. Basically, the positioning device can comprise the shape that you want the planar sensor to comprise later. For example, custom-fit planar sensors can be produced for attachment to the shoulder, for which the positioning device comprises a shape that is at least partially based on the shape of the shoulder.

However, the positioning device can also be designed as a plate or comprise a square as well as rectangular or also a polygonal (e.g., hexagonal) circumference. In all these embodiment types, the light guide wraps the positioning device on the circumferential side and a flat arrangement of light-guide sections is formed along the object surfaces of the positioning device.

However, the positioning device can also be made up of at least two rods positioned at a distance from each other and making a rotational motion in relation to each other so that the light guide wraps around the rods.

It has proved to be particularly favorable if the positioning device is designed in such a way that the cross-section of the positioning device, around which positioning device the light guide is wrapped, comprises a first extension that is significantly larger, preferably at least 50% larger, being particularly preferred, at least 100% larger than the second extension of the cross-section. The orientation of the first extension with respect to the second extension can be perpendicular. The first extension can indicate the width of the cross-section, and the second extension can indicate the height of the cross-section. Optionally, the cross-section of the positioning device can comprise the shape of at least one circular segment, preferably two circular segments whose chords come into contact each other. Here, the chord of the respective circular segment is preferably more than twice as large as the segment height, being particularly preferred, more than three times as large as the segment height. Likewise, there can be an elliptical shape of the cross-section, wherein the principal axis and the minor axis behave as before in relation to the rectangular cross-section. However, polygonal cross-sectional shapes can also be used, in which there can also be sections of circumference of equal length.

However, the positioning device for winding a light guide does not have to be operated purely in a rotational manner. For example, the positioning device can also be designed to perform translational movements or translational and rotational movements.

Preferably, the support element is placed only over a part of the positioning device or only over a part of the light guide or the surface formed by the coiled light guide. This automatically creates a plurality of parallel-running, free, i.e., non-fixed, light-guide sections away from the support element, which can then be bundled together to feed them to the reception detector.

Furthermore, it has proven to be very favorable that the light guide applied to the positioning device is subjected to heat treatment, preferably with a temperature in the range of 600° C. to 80° C., being particularly preferred, with about 70° C., in particular, hot air treatment.

Preferably, the light guide is exposed to heat treatment for at least 5 minutes, preferably at least 8 minutes, being particularly preferred, between 8 and 12 minutes.

The heat treatment must be carried out in such a way that the voltage in the light guide caused by the positioning of the light guide is reduced or so that the restoring forces in the light guide caused by positioning are reduced or completely disappear. The exact temperature curve of such a heat treatment depends on the material of the light guide and the conditions of positioning. When using a “polymeric optical fiber” (POF) as a light guide, it has been shown, for example, that a heat treatment of the light guide at approx. 70° C. for a time of 10 minutes results in the desired freedom from voltage of the light guide. In this state, heat treatment ensures that the light guide no longer moves out of its positioned position due to inherent restoring forces in the light guide and that the free ends of the light guide can subsequently be processed without any problems.

The heat treatment also leads to a reduction or even removal of the twist inherent in the light guide in the fixed light guide.

A plurality of heat treatments can also be used, for example, the light guide can be subjected to an initial heat treatment before being applied to the positioning device in order to ensure the most accurate positioning possible on the positioning device. This can be followed by a second heat treatment to apply the shape of the positioning device to the light guide and to reduce or remove the stresses or restoring forces in the light guide.

Heat treatment can also be carried out over a plurality of manufacturing steps.

In accordance with a further aspect of the invention, the light guide applied to the positioning device is severed along at least one line, with sufficient distance to the support element so that separate light-guide sections are arranged side by side on the support element, which end in non-fixed ends of the light-guide segments. Adjacent to the support element, where the light-guide segments are fixed, a plurality of free ends are created, which can then be combined in tufts, i.e., simply bundled.

The severing of at least one light guide can take place after fixation with the support element so that the course of the light-guide segments in the area of the support element is fixed. It is preferable to sever at least one light guide after heat treatment so that the previously mentioned restoring forces no longer play a role and the free ends can be processed without any problems.

The severance can be done in different ways. For example, a water jet can be used to sever the light guides. A rotating saw and/or a saw performing a lifting movement and/or pendulum movement can also be used to sever at least one light guide. The at least one light guide can also be severed due to a shear load, for example, by means of scissors or pliers. At least one light guide can also be severed by lapping. It has turned out to be particularly favorable if at least one light guide is severed by cutting with a knife, because this creates light emission surfaces that are unimpaired to the furthest extent possible. For this purpose, the positioning device can comprise a knife guide that guides the knife.

It has proven to be particularly favorable if discontinuities are introduced into the light guide on the side of the light guide facing away from the support element only after the light guide has been fixed on the support element. The discontinuities are formed on the finished planar sensor on the side facing the incidence of light. This measure is accompanied by the advantage that, for the first time, extensive discontinuities can be introduced on only one side of the light guide without the need for subsequent positioning, thereby taking the light-guide orientation into account.

Preferably, the discontinuities are only inserted in the area of the support element (sensor surface) and those areas in which only an optimal transmission of the light signal in the light guide is desired are carried out without discontinuities. This allows an optimal signal yield to be provided.

The manufacturing step of the discontinuities can be carried out before the heat treatment or simultaneously as the heat treatment, or after the severing of at least one light guide or after further intermediate steps. It is preferable if the discontinuities are introduced after heat treatment, which is favorable because the risk of displacement of the light guides caused by inherent restoring forces of the light guide is avoided when a mechanical force is applied to the light guides to create the discontinuities. As mentioned, these restoring forces are eliminated by heat treatment.

The discontinuities can be introduced mechanically, for example, by sandblasting or grinding, and/or chemically and/or by irradiation with particles or heat or electromagnetic radiation (laser light).

As already mentioned, the outer sheathing of the light guide is damaged in a circumferential segment by the introduction of discontinuities necessary for the light entry, wherein these damages are introduced at irregular intervals and at irregular positions with regard to the location. In this process, the original optical properties of the light guide are deliberately changed at those points that comprise the discontinuities, such as the reflection behavior of the outer sheathing of the light guide for example, which usually causes a total reflection of the light so that light can enter the light guide via the discontinuities.

It is therefore preferable to deliberately damage or roughen the surface of the light guide in order to introduce the discontinuities into the light guide.

When bundling, the light-guide sections that become free after being severed are combined into a bundle at the end. This can be done on one side of the support element or on both sides of the support element. The bundle can then be bonded in a substance-to-substance manner, for example glued, and/or inserted into a sleeve and held there. In particular, the sleeve-shaped edging of the free light-guide sections enables unproblematic, precisely defined further processing of the planar sensor.

The ends of the light guides can then be optically tempered, in particular, polished, to ensure optimized light signal transmission.

As discussed, only one light guide can also be used for the production of the planar sensor, which is applied to the support module in a flat contour, for example. In this case, a free end (or two free ends of a light guide) is created. In this case, the process of “bundling” is limited to providing a transition so that the single (or two) light guide end(s) provide for good light signal transmission. For example, a sleeve can also be applied to one end of the light guide to enable coupling with other components.

The bundle can now be connected to the reception detector in general, i.e., regardless of the number of light guides so that the planar sensor together with the reception detector forms the planar-sensor module discussed.

It has proven to be particularly favorable that the reception detector encloses the light guide or the light guides at the end in a sleeve shape. This means that the sleeve in which the light-guide segments are enclosed is inserted into a sleeve of the reception detector. This allows for optimal optical as well as mechanical coupling. The sleeve can be designed as a plug-in element that can be plugged into the reception detector in order to provide the best possible optical coupling there, which continues to protect against disturbing ambient light. The shape of the reception detector is therefore designed in such a way that the sleeve can be coupled with the reception detector in any case impervious to ambient light.

The light guide or light guides can be bundled at one end or both ends and coupled to at least one reception detector or, preferably, to two reception detectors. The bundling of the light guide or light guides at both ends has the advantage that an optimal light output is possible and thus incident light signals can be detected optimally.

The reception detector can comprise a light detector element that is designed to detect light. The light detector element is placed relative to the bundle of light guides in such a way that the light incident: into the planar sensor is essentially passed on to the light detector element undisturbed. The light detector element can be implemented as a photodiode or phototransistor, for example. Furthermore, a lens can also be provided that focuses the light emerging from the bundle towards the light detector element.

In accordance with a very compact embodiment type, such a planar-sensor module can detect incident light signals and pass this light signal directly to connected external processing devices that are designed to receive and further process the light signal.

However, the light signal is preferably converted into an electrical signal by the reception detector. In contrast to the purely optical signal, this electrical signal can then be transmitted essentially loss-free to an external processing device that is designed to receive and process the electrical signal.

Further signal processing can be carried out in different ways and can also be carried out by different units.

It is preferable to provide a plurality of reception detectors, each of which is coupled with a planar sensor.

A planar sensor can also comprise a plurality of bundles of such light guides at the free ends of the light guides, such as two bundles or a plurality of for example. These bundles of a single planar sensor can in turn be checked or evaluated independently of each other with regard to a light signal, i.e., for example they can be coupled with a reception detector or connected to a reception detector each. Thus, even within a planar sensor, it is possible to determine and differentiate in which area of the planar sensor an incidence of light occurred, i.e., a hit.

The individual planar sensors or even individual areas of a planar sensor can thus form individual hit surfaces. These individual hit surfaces can each be evaluated with a reception detector and these reception detectors can be coupled with each other via a bus system. Each reception detector is then assigned a reception-detector bus address.

However, if a plurality of hit surfaces are combined in a reception detector, each reception detector can also assign a hit surface address to each hit surface. Thus, with the aid of the hit area address and the reception-detector bus address, it is possible to differentiate very precisely in the overall system which planar sensor or which area of a planar sensor has received a light signal. This enables a very precise local resolution of the incidence of light. It can also be provided that the hit area addresses are dispensed with and only the reception-detector bus addresses are used. This can be favorable if larger areas of planar sensors are to be combined. The reception detector can be designed as a CCD sensor, for example, of which individual areas are assigned to a bundle of light guides.

There can also be a mixed implementation of these embodiment types.

Individual hit surfaces coupled in the bus system can essentially be applied to a (e.g., combat) suit over a large area or position-specific, which allows the wearer to move freely in a real environment completely unhindered and to form a realistic collection of hit zones that dynamically changes based on his own movement or the movement of the enemy. Software associates the various hit zones with body parts to which the respective position of the planar sensor on the person's body corresponds. This forms the basis for an injury-specific evaluation of the detected light signals.

As mentioned at the beginning, at least one planar-sensor module can be coupled with a processing module so that the planar-sensor group is formed, wherein the planar-sensor group is designed to provide or emit a data representation of the processed reception signal.

For this purpose, the electrical signal of the reception detector is further processed with the aid of the processing module and the information content transmitted with the aid of the light signal is extracted and made available with the aid of the data representation. This can be the mentioned weapon ID or a signal-emission device ID, the caliber of the weapon used, etc. By processing the signal into a data packet, it can be easily sent on, for example via a bus system to which the processing module is connected, or via radio communication. Further communication in the system is therefore simplified because, for example, the number of cables required for wired transmission is reduced. This allows for a more compact embodiment of the planar-sensor group, which increases wearing comfort when used in a suit, for example. The decentralized evaluation of the detected light signal also relieves the central module.

The processing of the electrical signal of the reception detector is primarily concerned with the processing module recognizing the logical symbols contained in the signal sequence using a communication protocol known to it, with which the information contained in the light signal is encoded. It is to be understood that the signal-emission device also uses this communication protocol to emit the information-coded light signal.

For the implementation of the radio-communication-based embodiment, the planar-sensor group can comprise a radio-communication module, with the aid of which it is possible to communicate, for example, with the central module or directly with the server or cloud-based software for further processing of the data representation

In accordance with a further aspect of the invention, the planar-sensor group, preferably the processing module, comprises a feedback stage which is designed to control the signal-emission layer of the planar sensor as a result of the occurrence of the reception signal. This measure makes it possible to make a detected light signal, which simulates a hit, directly recognizable during an exercise.

The feedback stage can be designed as a standalone feedback module that is connected to at least one processing module or the central module, and that generates feedback when a control signal is received. However, the feedback stage can also be combined with other components for example, such as the radio-communication stage, to form a module.

In accordance with a preferred embodiment type, the processing module comprises the feedback stage or is coupled with it or implements it.

With the help of the feedback stage, different feedback can be given in different places. The feedback is preferably given by means of the feedback layer of the planar sensor.

However, it can also be provided, for example, a light source (not integrated into the planar sensor), such as an LED for example, which lights up when a hit is detected. A vibration motor (not integrated into the planar sensor) can also be provided, which causes a vibration in the event of a detected hit, which can be perceived acoustically or felt, for example. Furthermore, a loudspeaker can also be provided that emits a sound signal or even a spoken cue when a hit is detected.

This feedback stage can also be designed to provide feedback in the immediate vicinity of the planar sensor. For example, a vibration motor can be located in the vicinity of the planar sensor or, as discussed, on the planar sensor itself so that the vibration signal is emitted directly in the vicinity of the hit. The same can apply to a loudspeaker or the like.

As discussed in the context of the signal-emission layer, the planar sensor can also be used or controlled to emit a light signal to provide feedback. For this purpose, for example, each light guide of the planar sensor can end in two bundles, wherein one bundle is contacted to the reception detector, while the other bundle is coupled to a light emitting unit that comprises a light source, in particular, an LED or a laser. The light emitting unit and the reception detector can also be designed as a single unit and attached to a bundle of the planar sensor. It should be noted that in both cases the reception detector and the light emitting unit must be coordinated. This can be done on the hardware side, for example, by the reception detector detecting lights of a different wavelength than those emitted by the light emitting unit. However, this can also be done on the software side so that the signal emitted by the light emission unit is filtered out of the detected signals, for example. The same applies to lights from the environment that should not be interpreted as hits, such as sunlight, room lighting or the like. If an encoded light signal is used, as preferred, it is particularly easy to recognize or other light sources can be filtered out particularly easily by appropriate signal processing.

The reception detector is preferably designed to receive a light signal that lies within a certain wavelength range, which is preferably detected by the reception detector or can pass through the bandpass filter in front of it. The light signal is preferably emitted as a square pulse signal matched to the reception detector, being particularly preferred with a fixed frequency. The information transmitted in this way is encoded in accordance with a communication protocol with the help of square pulses. This makes it easy to differentiate between the light signal to be detected and other light sources so that the reception detector is not disturbed or influenced by other light sources or ambient light, and as mentioned, the light-guide layer of the planar sensor itself can be adapted to provide optical feedback. However, an additional layer of light guides can also be provided to issue the optical feedback, wherein these light guides can be located under or light-guide layer (intended to detect the light signal) or border around it for example. As mentioned, a signal-emission layer with RGB LED can be located at the level of the vibra motors, wherein in the area of the RGB LED, a clipping of the reflector layer above allows the light-guide layer above to be illuminated.

The planar sensor, which is used to emit light via the discontinuities of the light guide, can be used to emit a colored, essentially areal light signal by choosing the light color. This can be used, for example, to divide the exercise participants into teams and to display their team affiliation. For example, there can be a team where the light sensors glow green and a team where the light sensors light up purple so that the exercise participants can be easily assigned to a team.

The light emission stage can also be controllable by the feedback stage or form part of the feedback stage. This allows a hit to be displayed at the location of the hit as visual feedback. For example, as soon as a planar sensor has been hit, it can turn red or light up red.

In summary, the planar sensor can therefore preferably be designed to emit an optical, haptic or acoustic signal, particularly under the control of the processing module and/or the central module.

As a result of a hit, the planar-sensor module itself, the central module and/or the central computer can, by means of the precise detection of the hit position, determine how serious this hit would be in a real situation and, where applicable, taking into account previous hits, evaluate whether an exercise participant is considered eliminated or not, which can be indicated, where applicable, by immediate feedback to the wearer of the planar sensor as well as the person positioned next to him/her can be communicated to exercise participants. For this purpose, a medical database can be stored in the system, for example in a storage stage of the central module or in a separate storage stage, which allows the degree or pattern of injury to be determined depending on the location of the hit and taking into account the simulated weapon or caliber. Depending on the severity of the injury, appropriate control signals can then be sent out.

As mentioned at the beginning, the planar-sensor module according to the invention can be used in the system or the system can comprise at least one of the planar-sensor modules according to the invention.

In addition to the planar-sensor module, the system can comprise other components. In particular, the system can also comprise the modules discussed above, namely the radio-communication module and/or the feedback module, or parts of these modules.

The central module can take on the role of a “master board” so that the central module processes the incoming information content, i.e., the light signals detected with the aid of the planar-sensor module, during the decision-making process. In particular, the central evaluation of the “hits” can be carried out with the inclusion of the aforementioned medical database, radio-communication-based communication with the central server can be handled in order to make the hit evaluation available centrally and in real time for exercise control, or, in the absence of a radio-communication connection, the hit evaluation can be temporarily stored for later radio-communication, line—or data-carrier-based transmission. Control commands or system-relevant data can also be received from the central server and subsequently used in the exercise process.

The signal processing can therefore be divided up between the central module, the processing module and the reception detector. If there are a plurality of planar-sensor modules in a system, the reception detectors can, for example, convert light signals into electronic signals or directly into digital signals and, where applicable, carry out a pre-interpretation, and the central module can be designed to receive and process these pre-interpreted signals. In the case of pre-interpretation, for example, an encoded signal can be decoded, and in further processing, a corresponding action can be triggered depending on the decoded signal. Of course, the work steps can also be divided up differently between the reception detector, processing module and central module.

Preferably, the signal-emission device already generates a light signal that transmits information, particularly encoded in square wave signals. If this light signal now hits the planar sensor, it is directed to the reception detector, where, particularly after the light signal has passed through a filter, particularly a bandpass filter, an electronic signal is generated on the basis of the light signal. Preferably, the reception detector generates an electrical square wave signal, i.e., digitizes the received light signal. This is then interpreted by the processing module and its information content is transmitted digitally to the central module via the bus system.

However, if the reception detector emits an analog signal, this can also be digitized by the processing module before it digitally transmits or transmits the information content via the bus system.

In the central module, the information content can be further interpreted and, where applicable, compared with databases. Control signals can then be sent out. In the case of a tracksuit, these can concern, for example, the usability of the signal-emission device of a hit exercise participant, as has already been discussed at the relevant point. A signal can also be transmitted to the central computer so that it can create statistics regarding the exercise. However, control signals can also be sent out before the central module has processed the information content or during it. For example, as soon as the processing module receives the electronic signal from the reception detector, it can send out a control signal to give feedback or to control the signal-emission layer. Thus, for example, an exercise participant knows immediately that he has been hit.

In order to keep the bus system, and thus the system, compact, the following addressing can be used, for example: The processing module has a plurality of input channels, for example, eight of them. A reception detector coupled to a planar sensor is attached to each of these channels. Each of these channels and thus each reception detector or planar sensor has a unique number, i.e., a unique channel number. Furthermore, the processing module comprises a unique bus address that uniquely identifies the processing module within the bus system. The bus address in combination with the channel number thus clearly represents a planar sensor and thus a body region to which the planar sensor is assigned, which is stored in the central module.

In this exemplary embodiment, the bus address and the channel number can be combined to form a planar sensor ID, for example by adding the channel number, which can be represented by only one digit in the decimal system if there are fewer than 10 channels, after the bus address. For example, the bus address “001” and the channel number “4” result in the planar sensor ID “0014”. The central module, which receives this planar sensor ID via the bus system, can therefore immediately identify the affected body region or trigger further actions based on this planar sensor ID in combination with the information transmitted by the light signal (and subsequently digitized). In this way, the central module can compare in a database whether or not a hit in this particular region of the body would incapacitate the exercise participant with the transmitted caliber provided by the transmitted light signal. If the former is the case, actions can be triggered that inform the exercise participant about this and prevent him/her from continuing to emit signals with his signal-emission device, as has already been discussed at the appropriate point.

Apart from the aforementioned central radio-communication module, which is assigned to the central module, a plurality of radio-communication modules can also be provided in a system in order to connect individual components of the system with each other or with the central module on a radio-communication basis.

For example, a suit used can be divided into two parts, e.g., into trousers and a jacket, and each suit part can comprise its own radio-communication module so that the parts of the suit can be connected to the central module without a cable connection. Furthermore, each planar-sensor group, for example, can comprise a separate radio-communication module. With these measures, easily damaged cables or wires can be reduced or even avoided, which makes such a tracksuit easier and more agile to maneuver or use. This also makes it easier to put on and take off the suit.

The individual reception detectors can also each comprise a radio-communication module so that they can communicate wirelessly either with the processing module assigned to them or directly with the central module. For example, a plurality of reception detectors can be combined in one radio-communication module in order to provide this radio-communication functionality in a grouped manner.

An action that is triggered in the operating procedure of the system as a result of the detection of a light signal can therefore include, for example, the emission of feedback via the feedback stage, or the transmission of a signal or data via the radio-communication stage.

When using the planar-sensor module as a device cover covering a weapon used for the exercise that comprises a signal-emission device, or as a device cover of a signal-emission device, the action can involve simulating that the weapon (or signal-emission device) is damaged. For this purpose, the emission of the signal light by the corresponding signal-emission device is prevented as an action. This can be used in an equivalent way for a vehicle equipped with an equipment cover. For example, if a vehicle is hit at a corresponding point, the engine can be switched off as an action or simply the people in the vehicle can be informed that the vehicle can no longer be moved due to engine damage.

When using the planar sensor to cover a person, i.e., particularly when using the planar-sensor module in a combat or sports or tracksuit, it is possible to cover the person with planar sensors so that the person forms a full-surface hit zone, within which differentiated, position-specific hit registration is possible by segmenting the hit zone with individual planar sensors. (Of course, the same applies in an equivalent way to device or component covers). Furthermore, the wearer wearing a combat or sports or tracksuit equipped with planar sensors or gaming suit can move freely without being hindered by the planar sensors, because the planar sensors are very flat and flexible, and therefore, they adapt well to the deformation of the suit.

The planar-sensor module and/or the combat or sports or tracksuit or gaming suit can comprise a display that provides the wearer with information. For example, the display can show how long an exercise will last. The display can also give exercise participants instructions, such as that he/she should leave the exercise area after the central computer, the central module or the processing module has determined the need to withdraw from the exercise for example.

It should be noted again that the subjects discussed are of course not only applicable to the conduct of military exercises, but also in an equivalent way to the conduct of police exercises or the like, or for recreational and/or athletic exercises.

Furthermore, it should be mentioned that the planar sensor or the planar-sensor module can also be used outside of the exercises discussed here. This means that the planar sensor can also be used in a secure locking system, particularly for buildings and in the automotive sector.

Here, a planar sensor according to the invention is coupled with a reception detector to a locking system. The reception detector, which can be followed downstream by a processing module for this purpose, only passes on the correct signal to the locking system for unlocking or opening the locking system if a coded light signal enters the planar sensor and this light signal comprises the correct code. By coupling the planar sensor to the locking system, a locking system can be implemented that makes eavesdropping impossible through the use of the point-shaped light source with data coding in the light signal, because there must always be visual contact between receiver and transmitter, which excludes a “man in the middle attack”.

Finally, it should be mentioned in general terms that the electronic devices discussed naturally comprise electronics. The electronics can be discrete or built by integrated electronics or also a combination of both types.

Microcomputers, micro-controllers, application-specific integrated circuits (ASICs), possibly in combination with analog or digital electronic peripherals, can also be used. Radio-communication devices usually comprise an antenna configuration for transmitting and receiving radio-communication signals as part of a transceiver module. Rechargeable or replaceable batteries or own power supply units can also be used for electrical energy supply.

These and other aspects of the invention emerge from the figures discussed below.

### BRIEF DESCRIPTION OF THE FIGURES

The invention is explained in more detail below with reference to the attached figures on the basis of exemplary embodiments, to which, however, the invention is not limited. Thereby, identical components in the various figures are provided with identical reference numbers. The figures schematically show:

FIG. 1 a planar sensor in cross-sectional view,

FIG. 2 a layer structure of the planar sensor in a perspective illustration,

FIG. 3 the planar sensor with light guides bundled at the end,

FIG. 4 an enlarged illustration of a section of FIG. 3 with the bundled light guides,

FIG. 5 a lateral view of the planar sensor and the light guides bundled on the end side,

FIG. 6 a coupling of the light guides bundled on the end side with a reception detector,

FIG. 7 a cross-section of the light guide with discontinuities at its circumferential segment and the principle of light conduction,

FIG. 8 a longitudinal section along a section of the light guide with its discontinuities and the principle of light guidance,

FIG. 9 a block diagram of a system with two planar-sensor groups,

FIG. 10 a military application scenario for the planar sensor,

FIG. 11A a tracksuit with planar sensors,

FIG. 11B a block diagram of an electronic system of the tracksuit in accordance with FIG. 11A,

FIG. 12 a block diagram of a signal-emission device, for emitting a coded light signal that can be received with the aid of the planar sensor,

FIGS. 13-19 steps of a manufacturing method of a planar sensor,

FIGS. 20-23 details another exemplary embodiment of the planar sensor.

FIG. 24 a third exemplary embodiment of the planar sensor with light guides bundled on both sides

### DESCRIPTION OF THE EXEMPLARY EMBODIMENTS

FIG. 1 shows a planar sensor 1 in a sectional view. The planar sensor 1 comprises light guides 2, which are positioned directly next to each other, in particular adjacent to each other and parallel to each other so that the light guides 2 form a light-guide layer 3. The light guides 2 are fixed by a support element 4, wherein the support element 4 in this exemplary embodiment is shown as an essentially transparent binder, in particular a glue, in which the light guides 2 were embedded in order to fix their position.

Furthermore, the planar sensor 1 comprises a diffuser layer 5, a semipermeable mirror layer 6 and a reflector layer 7. Layers 5-7 are arranged here in a sandwich structure so that an incident light signal 8, which is formed by a precisely focused laser beam, first passes through the diffuser layer 5, where it is scattered, which leads to a widening of the light signal 8, then passes through the semipermeable mirror layer 6 and then reaches the light-guide layer 3. Further following this direction, after the light-guide layer 3, there is the reflector layer 7, which is 50 in that it reflects the light signal 8, which has found its way through the light-guide layer 3 or past the light guides 2, and can also comprise exited the light guides 2. The semipermeable mirror layer 6 allows the light signal 8 to enter the planar sensor 1 as unhindered as possible and ensures that the light signal 8, once it has entered the planar sensor 1, can no longer exit the planar sensor 1. At least the potentially escaping part of the light signal 8 is reduced by the mirror layer 6.

In the present case, the structures shown in FIG. 1 (reference numbers 5, 6, 3, 4 and 7) are shown at a relatively large distance from each other in order to discuss the light progression in planar sensor 1. In a realistic embodiment type, the structures mentioned can essentially be positioned directly adjacent to each other.

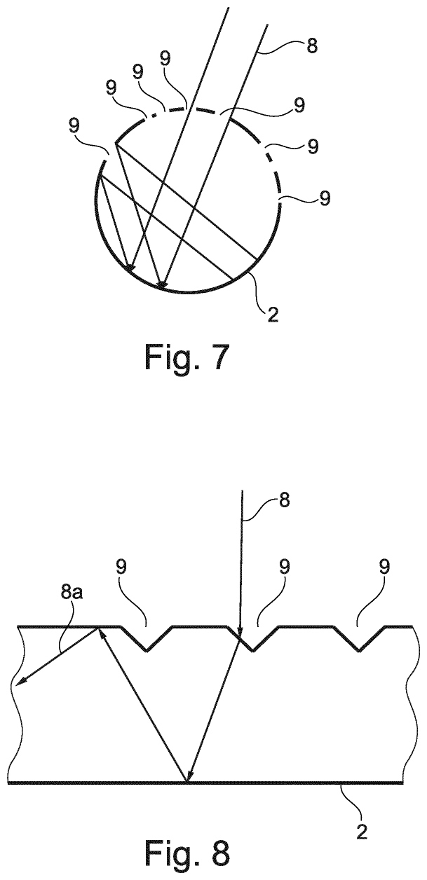

The light guides 2 comprise discontinuities 9 (not explicitly shown in FIG. 1 but see FIGS. 7 and 8) which enable or favor the entry of light into the light guide 2. These discontinuities 9 are inserted on the side of the light-guide layer 3 that is positioned adjacent to the semipermeable mirror layer 6, because the light falls from there. The side of the light-guide layer 3 that is positioned adjacent to the reflector layer 7 is free of discontinuities 9.

In detail, FIG. 7 shows the cross-section of light guide 2. The discontinuities 9 are indicated here as interruptions of the circumferential line. The discontinuities 9 are applied approximately along half the circumference of the light-guide cross-section. Thus, the light signal 8 can penetrate the light guide 2 along the largest possible angular segment along the circumference through the discontinuities 9 and be reflected in the areas of the light guide 2 at the areas of the light guide 2 without any discontinuities so that the light signal 8 essentially only propagates in the light guide 2.

In detail, FIG. 8 shows a longitudinal section of a section of light guide 2. The discontinuities 9 are located on the side of the light guide 2 shown above, while the lower side of the light guide 2 comprises no discontinuities 9. For better visualization, the discontinuities 9 are shown as very large indentations. However, the discontinuities 9 can also be much finer. As discussed, the light signal 8 enters the light guide 2 through the discontinuities 9 and is directed to the free ends by refraction and/or reflection in the light guide 2.

In FIG. 1, a light signal 8 hits the planar sensor 1. The light signal 8, which hits the planar sensor 1, is scattered when it passes through the diffuser layer 5 or the cross-section of the light signal 8 is extended so that, after passing through the semipermeable mirror layer 6, it hits a plurality of light guides 2 and thus increases the chance of light entering through the discontinuities 9 into the respective light guide 2.

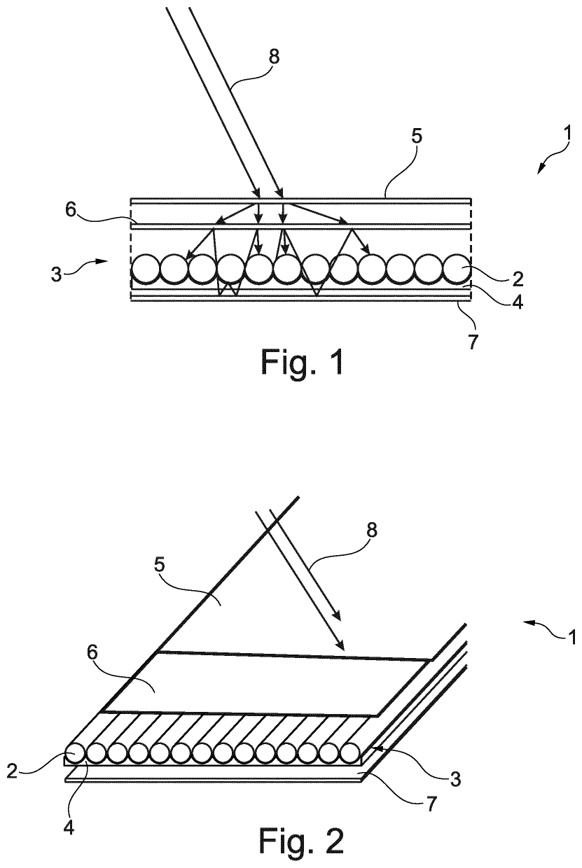

FIG. 2 shows the planar sensor 1, which is also shown in FIG. 1, in a three-dimensional representation (perspective), wherein its individual components or layers 3-7 are offset from each other in order to make all layers 3-7 clearly visible. This type of representation can also be understood as an exploded drawing.

FIG. 3 shows the planar sensor 1, wherein the light guides 2 are grouped and fixed to the light-guide layer 3 by means of the support element 4. The light guides 2 each comprise a section 10 that is free on one side, i.e., a section that is not fixed with the support element 4. The free sections 10 of the light guide 2 are combined on the edge and end sides to form a bundle 44, which is enclosed by a sleeve 11. The sleeve 11 holds the light guide 2 of the bundle 44 in position and simultaneously enables a coupling of the planar sensor 1 with a reception detector 13, which is discussed in FIG. 6.

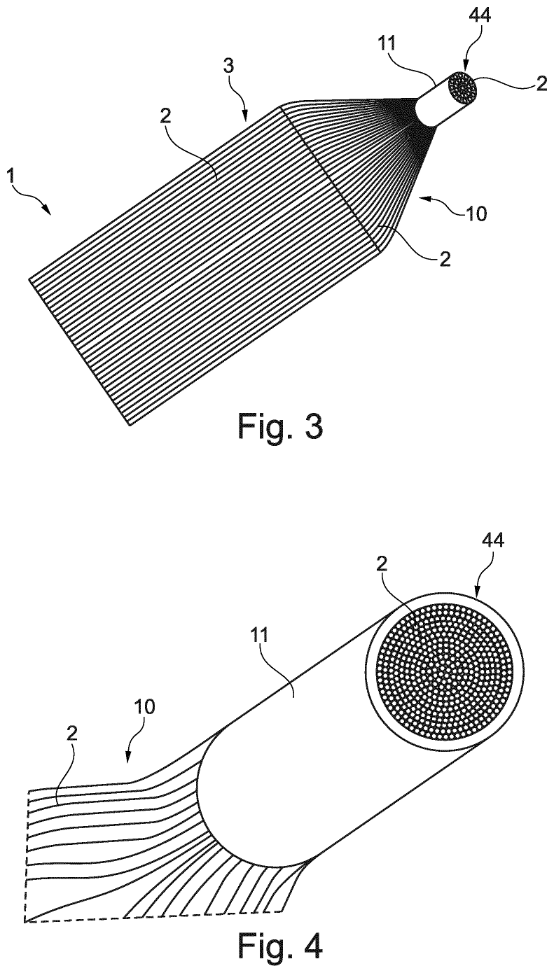

FIG. 4 shows an enlarged view of the free sections 10 of light guide 2 as well as the bundle 44 and the sleeve 11. The ends of the light guide 2 are optically tempered in order to enable the light entering them to be transmitted as discontinuity-free or reflection-free as possible.

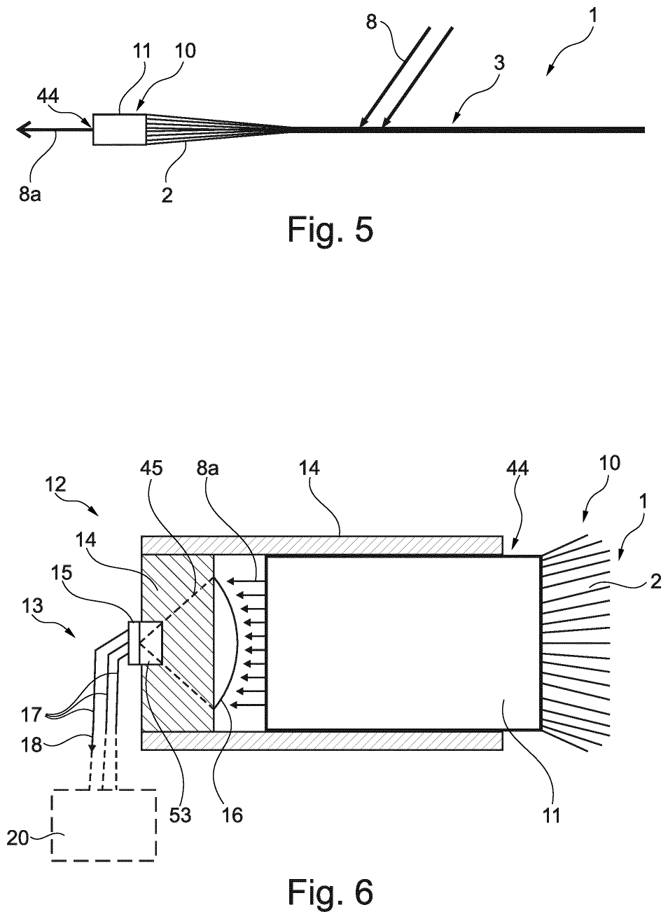

FIG. 5 shows the planar sensor 1 in a flat position, wherein the flat light-guide layer 3 (with the layers above and below—these are not shown and marked in detail here) on the right side of FIG. 5. In this diagram, the smallest extent of the planar sensor 1, i.e., the height or thickness of the planar sensor 1, can be seen. To the left of the areal light-guide layer 3 are the bundled free sections 10 of the light guide 2, which are enclosed in the sleeve 11 or thereby sheathed.

As discussed, the light signal 8, which hits the planar sensor 1, enters the light guide 2 via the discontinuities 9 and is directed from there to bundle 44, where it again leaves the planar sensor 1 as a guided light signal 8a. From there, the guided light signal 8a can be further processed electronically, for example, as discussed in the context of the following figures.

FIG. 6 shows the sleeve 11, which bundles the light guides 2 of the planar sensor 1, coupled with the reception detector 13.

The reception detector 13 comprises a housing 14 for this purpose, which comprises a cylindrical recess in which the sleeve 11 is located in a nonpositive-locking manner, i.e., it is plugged in. Within the reception detector 13 there is a photodiode 15 as a light detector element. Between the photodiode 15 and the sleeve 11, there is a convex lens 16, which directs the light emerging from the light guides 2 to the photodiode 15. The housing 14 is designed in such a way that only light that has been guided through the planar sensor 1 reaches the lens 16 and then the photodiode 15. For this purpose, the housing 14 is designed to be impervious to light and the reception detector 13 in the area between the lens 16 and the photodiode 15, i.e., the part of the housing 14 which supports the photodiode 15 or in which the photodiode 15 is embedded, is funnel-shaped, which is indicated by the line 45 from the photodiode 15 to the lens 16 by dashed (broken) lines.

Furthermore, the reception detector 13 in this exemplary embodiment comprises a bandpass filter 53, which allows only frequencies to pass through that correspond to the wavelength of the light signal 8 emitted by the signal-emission devices 33 provided for this purpose.

The reception detector 13, for example, can be implemented with the aid of a very compact, integrated device that comprises the aforementioned components and converts an analog light signal into a digital electrical signal. An example of this can be an infrared receiver made by Vishay called the TSOP4838.

A light signal 8 that hits the planar sensor 1 is therefore passed through the sleeve 11 as a guided light signal 8a into the reception detector 13, where it hits the lens 16, which focuses the guided light signal 8a on the photodiode 15. The photosensitive area of the photodiode 15 is shielded from ambient light in order to ensure an optimal connection, both mechanically as well as optically, to the planar sensor 1 and to be able to make optimal use of the guided light signal 8a from the light guide 1.

When the guided light signal 8a appears, the photodiode 15 generates an electrical signal 18. The photodiode 15 thus converts the transmitted light signal 8a into an electrical signal 18, which can be tapped at its contacts 17 and then further processed.

The planar sensor 1 in combination with exactly one reception detector 13 together forms a compact version of a planar-sensor module 12. This is a minimal configuration of the planar-sensor module 12, in which the provided electrical signal 18 must be further processed by another unit. For this purpose, such a planar-sensor module 12 can comprise its own processing module 20, as indicated in FIG. 6.

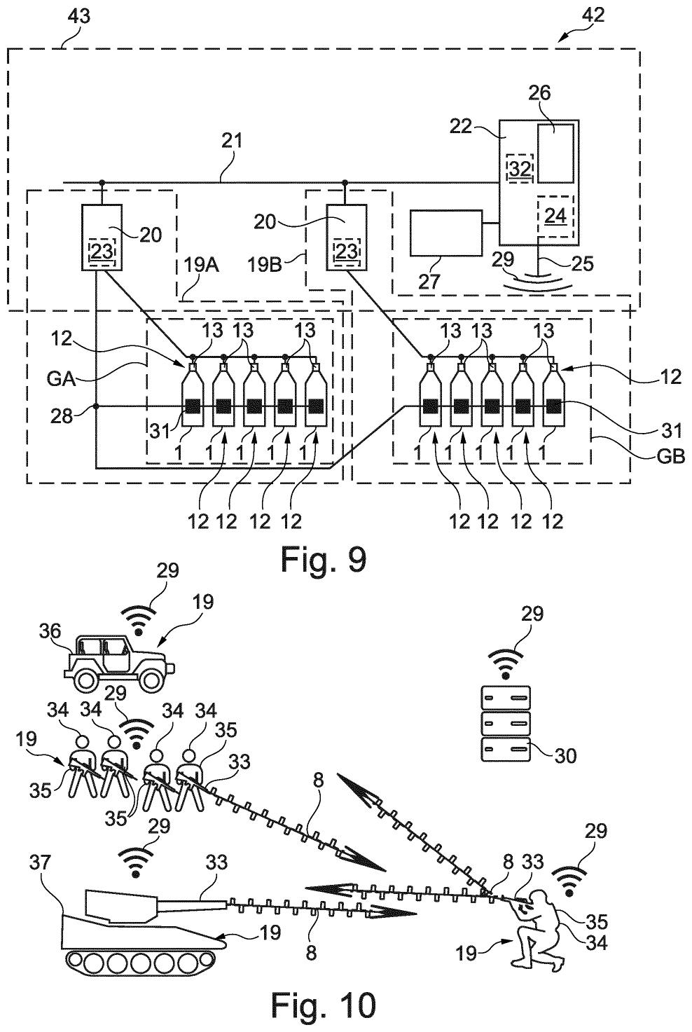

However, the configuration shown in FIG. 9 is preferred, where a plurality of planar-sensor modules 12 are combined with a common processing module 20, thus forming a first planar-sensor group 19A and a second planar-sensor group 19B.

The processing module 20, which assumes the role of a submodule, comprises a number of slots corresponding to the respective number of reception detectors to be coupled 13 so that the individual electrical signals 18 can be received and processed separately. In both configurations, the processing module 20 performs a preprocessing of the electrical signal 18 received from the respective reception detector 13. The processing module 20 “packages” either the raw data of the electrical signal 18 or its data content, i.e., generally user data, in each case into a data packet or data structure so that in addition to the user data, a processing module ID and/or a planar sensor ID and/or a planar-sensor group ID is included. The processing module ID uniquely identifies the processing module 20 that was involved in the acquisition of light signal 8. The planar sensor ID uniquely identifies planar sensor 1, which was involved in the acquisition of light signal 8. The planar-sensor group ID uniquely identifies the planar-sensor group 19A or 19B that was involved in the acquisition of light signal 8. This data structure is provided by the processing module 20 for further processing or is emitted by it.

Processing Module 20 is further designed to drive a feedback stage 23 contained in the respective planar-sensor group 19A, etc., for the purpose of providing feedback to a user of the system 1. Feedback stage 23 is preferably a component of processing module 20 to relieve the load on central module 22 and thus provide real-time feedback at the local level, i.e., at the level of planar-sensor group 19A, etc., or even a single planar sensor 1.

FIG. 9 shows a system 42 for detecting and processing light signals 8. The system 42 shown here as an example comprises ten planar sensors 1, wherein five planar-sensor modules 12 and one processing module 20 are combined to form the respective planar-sensor groups 19A and 19B. Each of the planar-sensor modules 12 comprises the planar sensors 1 and the reception detector 13 coupled to it. The planar-sensor modules 12 are combined in five pieces each with the processing module 20 of the corresponding planar-sensor group 19A or 19B in a wired manner.

Each processing module 20 comprises a bus processor for data or signal processing, which converts the electrical signal 18 into a digital signal and, as discussed, provides the contained user data with a planar-sensor group ID, i.e., supplements it, and the data packet generated in this way via a bus system 21 is passed on to a central module 22, which is also referred to as a as a master unit or “master board”.

In the present case, bus system 21 is designed for wired data transmission. The central module 22 receives the data packets transmitted via bus system 21 and evaluates them further.

The central module 22 comprises a storage stage 32 for internal storage of data and/or signals and a screen 27 for displaying information to a user and a USB interface 26 for local emission or reception of data. The central module also comprises a radio-communication stage 24 for radio communication with external devices.

The radio-communication stage 24 is designed to communicate with an external computer, or server 30 (see FIG. 10) via radio communication 29. For this purpose, radio-communication stage 24 comprises an antenna configuration 25, for which a mere indication is made.

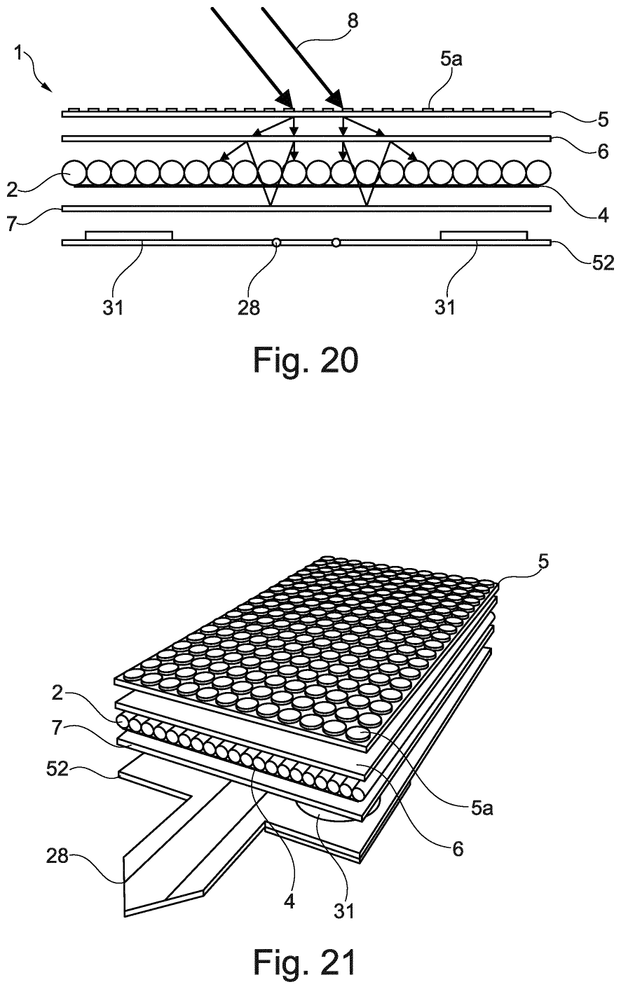

As mentioned, feedback stage 23 is included in the processing module 20. The processing module 20 is in turn connected wirelessly to a feedback-signal channel 28. The feedback-signal channel 28 is a control line configuration that connects the processing module 20 with the respective feedback-giving element of the planar sensor 1 so that this feedback-giving element can be controlled with the aid of an electrical signal. The feedback-signal channel 28 is used to control vibration motors 31, each of which is attached to the planar sensors 1 below the reflector layer 7. The vibration motors 31 are therefore located in a signal-emission layer (see FIGS. 20, 21 and 23) of the respective planar sensor 1, from which feedback signals can be emitted. Under feedback stage 23 control, the vibration motors 31 are switched on and off together or for each planar-sensor group 19A and 19B or individually. With the aid of the vibration motors 31, the detection of a light signal 8 received with the aid of the respective planar sensor 1 can be communicated by vibration as feedback.

Furthermore, it should be mentioned that each reception detector 13 can comprise a light emission unit (not explicitly shown), which is also controlled by the processing module 20, for example, via the feedback-signal channel 28. This allows a feedback light signal generated internally in the respective planar-sensor group 19A, 19B to be fed into the planar sensor 1 so that it glows in a predefined or freely definable color. In this optional embodiment, the respective planar-sensor group 19A, 19B can also comprise a decentralized feedback stage 23 (not shown).

In summary, the central module 22, the bus system 21 and the planar-sensor groups and 19A 19B provide processing electronics 43, which processes or interprets the causative light signals 8. It should be noted again that the individual components of processing electronics 43, as well as the functions provided by the individual components of processing electronics 43, can also be divided up differently. For example, the planar-sensor module 12 can also be designed to assume all the functions of the central module 22. The same applies to the planar-sensor group 19A or 19B. For example, each processing module 20 can also comprise the entire functionality of processing electronics 3 in a decentralized manner.

FIG. 10 shows a military application scenario for the planar sensor 1, specifically a military exercise, in which the planar sensor 1 is used to detect hits of projectiles simulated with the aid of light signals 8.

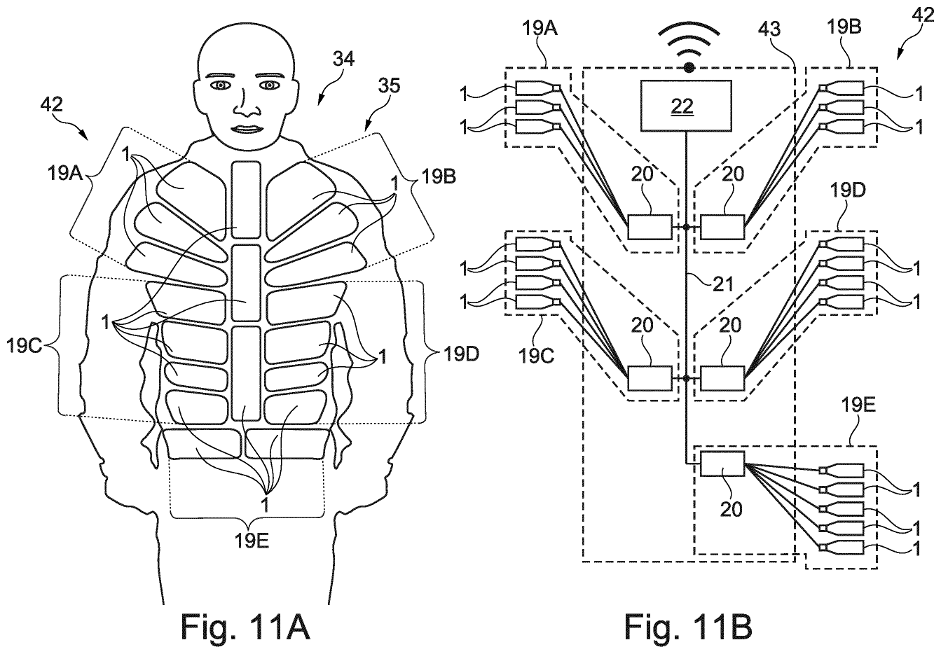

Five exercise participants 34 take part in the exercise, wherein each wears a tracksuit 35 (see FIG. 11A in detail) that comprises a number of planar-sensor groups 19.

Each exercise participant 34 carries a weapon (a rifle) loaded with blanks and which comprises the signal-emission device 33, which is used to simulate the firing of a rifle projectile.

As is graphically indicated in the figure, the signal-emission devices 33 are designed to emit a coded, in particular, modulated light signal 8.

Furthermore, there are two vehicles at the training area, namely an off-road vehicle 36 and a tank 37, which comprise at least one planar-sensor module 12 or a planar-sensor group 19 attached to their outer vehicle shell. The planar-sensor modules 12 used are designed as device covers. The tank 37 also features a signal-emission device 33, which is used to simulate the firing of an armor-piercing artillery shell by the tank 37.

The planar-sensor modules 12 present on the different objects (human and device) are—as discussed by way of example in connection with FIG. 9—each combined into planar-sensor groups 19 and connected to central modules 22 located at the respective object, which connected are via radio-communication module 24 to the central server for the evaluation of the combat situation, as discussed in connection with FIG. 9.

A weapon type ID can be used to determine which bullet or caliber is simulated by the light signal 8. For example, if a planar sensor 1 on the ATV 36 is hit by a light signal 8 that bears the weapon type ID of the tank 37, this hit is interpreted as meaning that the ATV 36 is considered damaged and can no longer be used, regardless of the location of arrival. For example, a text can be displayed on screen 27 announcing that the off-road vehicle 36 is no longer operational. However, the planar-sensor module 12 can also be connected to the engine control system of the off-road vehicle 36 and prevent the engine of the off-road vehicle 36 from starting after such a hit. The affected planar sensor can also light up in a clearly perceptible signal color to convey this situation.

However, if the off-road vehicle 36, or the planar sensors 1 on the off-road vehicle 36, is hit by a light signal 8 that carries the weapon type ID or the caliber variable of an assault rifle, this training mode evaluates whether the off-road vehicle 36 is still considered functional or not, depending on the location of the hit, the number and the locations of the previous hits.

In this exercise, the exercise participants 34 can be divided up into teams. For this purpose, their tracksuits 35 are each designed to illuminate the planar sensors 1 in team colors by means of the light emission units so that the team affiliation is visible to all exercise participants 34. If an exercise participant 34 is hit, the color of the hit planar sensor 1 changes to a predefined color that indicates this circumstance.

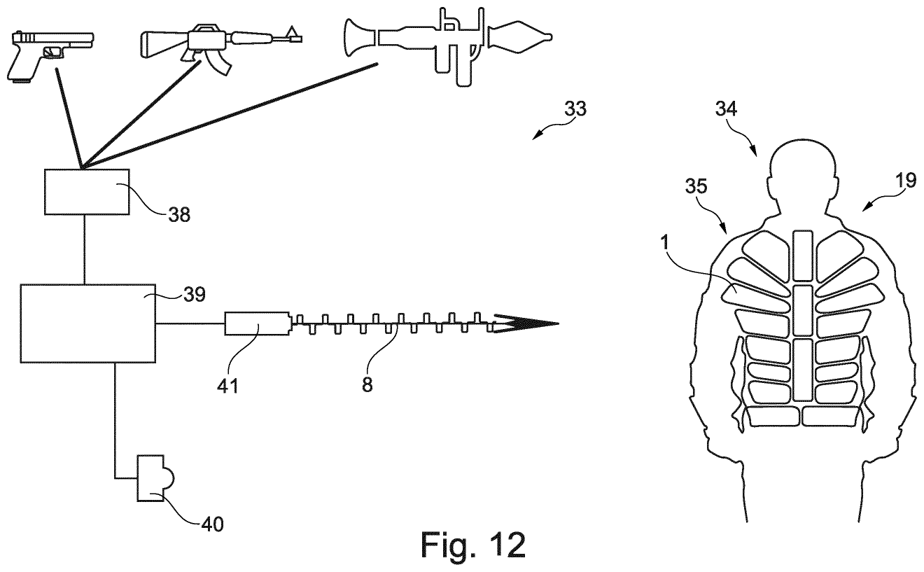

In this application scenario, the respective processing module 20 is designed to evaluate only coded light signals 8 as hits. Signal-emission devices 33 (see FIG. 12) are provided for this purpose, which emit correspondingly coded signals as light signals 8, in particular, individually coded ones. In this exemplary embodiment, this coded light signal 8 has a shooter ID or a signal-emission device ID embedded in it, which indicates from which signal-emission device 33 or from which shooter the light signal 8 was emitted. A weapon type ID/caliber is also embedded in the light signal 8, which indicates which weapon or caliber is simulated by the signal-emission device 33, or on which weapon the signal-emission device 33 is attached. The time of the signal emitted and a sequential number indicating the number of times signals have already been emitted can also be embedded in light signal 8.

If a light signal 8 now hits one of the planar sensors 1, the incoming light signal 8 is directed as a guided light signal 8a to the respective reception detector 13 and detected there. The reception detector 13 converts the guided light signal 8a that arrives at it into the electric, digital signal 18, which is transmitted to the processing module 20. The processing module 20 interprets the electrical signal 18. In this case, it can be checked again whether the signal is an encoded signal, i.e., a signal that requires or enables interpretation by the processing module 20 and/or the central module 22. In general, however, only those signals that are in the corresponding wavelength range are allowed through by the reception detector 13. If it is a coded signal, the processing module 20 transmits the digital signal as well as the planar-sensor group ID to the central module 22 via the bus system 21. The central module 22 now decodes the coded signal and determines who and in particular which type of weapon the hit came from. This is now stored in storage stage 32 and simultaneously transmitted to server 30 via radio-communication module 24 and evaluated by central module 22 itself.

As soon as the processing module 20 has correctly interpreted an incoming electrical signal 18, i.e., has classified it as a valid hit, it sends a feedback signal via the feedback-signal channel 28 to the relevant planar-sensor group 1 or to one or a plurality of selected planar sensors 1 in order to generate feedback for exercise participant 34. As a result, the optical light emission unit of the reception detector 13, which is coupled with the hit planar sensor 1, lights up red and the vibration motors 31 of the hit planar sensor 1 emit a vibration signal. The screen 27 displays a text that informs the exercise participant or participants about a hit and its real expected impact. Furthermore, the text can contain further instructions, such as that an exercise participant is considered to have been eliminated and should leave the training field, or that an object, such as a vehicle equipped with the planar-sensor module 12, is considered non-functional and can no longer be used in the course of the exercise.

For analysis purposes, the data collected and stored in storage stage 32 can be retrieved from server 30 via radio communication after completion of the exercise or read out via USB interface 26. The storage stage 32 can also be implemented as a removable storage drive (such as an SSD hard drive or a USB memory, i.e., a so-called USB stick).

Via the USB interface 26 and/or via the server 30, different exercise modes can also be imported into or transferred to the central module 22 in the form of exercise mode definition data. For example, a practice mode can allow you to fire counter-shots in a certain area of planar-sensor group, such as 19A for example, in a certain period of time after a hit, while you are immediately eliminated if you hit in the other planar-sensor group 19B. The exercise modes thus provide rules on how hits in different planar-sensor groups 19A or 19B are to be interpreted.

As mentioned, a medical database can also be stored for this purpose so that the hits are assigned an injury pattern typical of such a hit depending on the signals or data transmitted with the light signal 8, for example, the weapon type or the caliber of the simulated ammunition or weapon. This assignment can be carried out autonomously by the central module 22. Depending on the injury pattern, the further actions can then be triggered by the central module 22 (or also by the processing module 20). As discussed, these actions can include, for example, transmitting a control signal to the signal-emission device 33 so that the firing of the shot is stopped after a certain period of time, which depends on the pattern of injury. This action can also include giving feedback as discussed and/or transmitting a corresponding signal or data regarding the hit to the server 30.

For athletic exercises, other exercise modes are also possible so that an exercise participant 34, for example, is only considered eliminated after a plurality of hits, etc.

FIG. 11A shows the tracksuit 35 with planar sensors 1 attached to the front side of the tracksuit 35 as an example. Planar sensors 1 are combined into five planar-sensor groups 19A, 19B, 19C, 19D, 19E. The first planar-sensor group 19A covers the right chest of exercise participant 34. The second planar-sensor group 19B covers the left chest of exercise participant 34. The third planar-sensor group 19C covers the right abdomen of the exercise participant 34. The fourth planar-sensor group 19D covers the left abdomen of the exercise participant 34. The fifth planar-sensor group 19E covers the sternum, part of the middle abdomen and part of the pelvis of exercise participant 34.

Other planar-sensor groups 19, for example, can be provided on the back, legs and/or arms or also on the head.

FIG. 11B shows the block diagram of the interconnection of the planar sensors 1 of the tracksuit 35 or the system 42 in accordance with FIG. 11A.

Basically, the tracksuit can comprise a single system 42 or a plurality of systems 42. For example, another, similarly structured system 42 made of planar-sensor groups 19 can be attached to the back. Separate systems 42 can also be attached to the arms and legs. The individual systems 42 can communicate with each other wirelessly or be connected to server 30. By dividing it into individual systems that are assigned to individual articles of clothing, it can be simplified to put on and take off the individual articles of clothing belonging to the tracksuit 35, because the radio-communication coupling of the individual systems 42 does not require continuous cabling across the individual garments. Furthermore, the (free) freedom of movement of the exercise participants 34 is also maintained during the exercise, because no continuous cables or the like restrict the movements.

FIG. 12 shows a rough block diagram of the structure of the signal-emission device 33. The signal-emission device 33 comprises a weapon type selection module 38, which can be used to select the weapon type or caliber on which the signal-emission device 33 is attached or which is to be represented by the signal-emission device 33. Furthermore, the weapon type selection module 38 comprises a USB interface with which new weapon types can be imported. After selection, the selected weapon type is emitted in the form of the weapon type ID with the light signal 8 when the weapon is fired. The weapon type selection module 38 is connected to a signal-emission processing module 39, which is still connected to a trigger 40 and a light source 41. The light source 41 is designed as a laser light source and is designed to emit the coded light signal 8.

The trigger 40 is designed as an interchangeable module. For the use of the signal-emission device 33 in combination with a dummy weapon, a module can be used in which the trigger is implemented as a simple contact or a pushbutton. When using the signal-emission device 33 in combination with a real weapon loaded with blank bullets, the trigger can be designed as a sound event detection unit that detects a firing of the weapon based on the sound and then triggers a signal emission.

A trigger contact can also be provided, which makes the operation of the trigger electronically available.

Furthermore, the trigger 40 can be implemented by means of a 3D exposure sensor so that the trigger 40 triggers a signal emission when a characteristic acceleration pattern is detected when firing a weapon. In particular, this can be combined with the sound event detection unit.

When the trigger 40 activated, the signal output processing module 39 generates the coded signal, which comprises the signal-emission device ID and weapon type ID/caliber ID, among other things, and instructs light source 41 to emit the coded light signal 8.

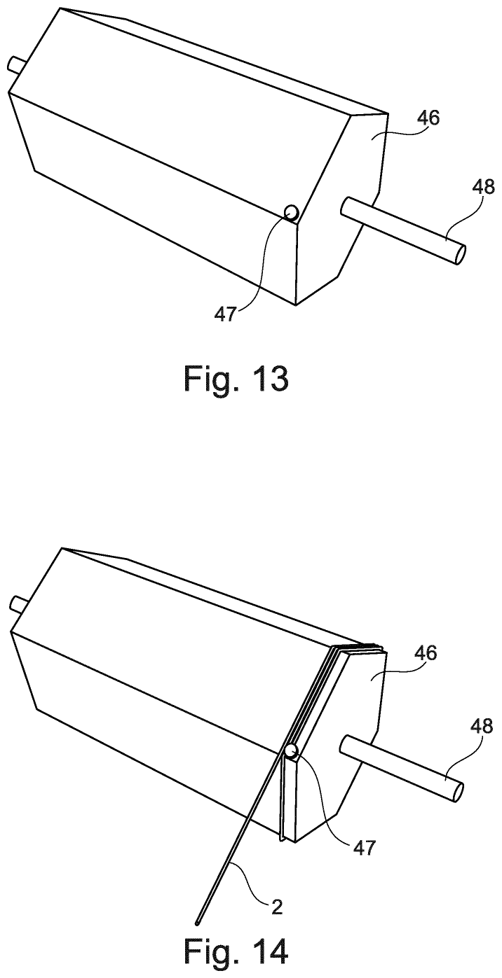

Exemplary steps of the manufacturing method of the planar sensor 1 are visualized in FIGS. 13 to 19.

FIG. 13 shows a positioning device 46, which is intended to wind up a light guide 2. The positioning device 46 comprises a shaft 48 that can be driven by a motor that is not shown. Furthermore, the positioning device 46 is supported by the shaft 48 so that the positioning device 46 can be rotated around the axis of the shaft 48. The positioning device 46 comprises a hexagonal cross-section, resulting in six surfaces on which the light guide 2 can be wound on there in a flat position. Furthermore, the positioning device 46 comprises a light-guide fixing device 47, which is intended to temporarily fix the light guide during winding. In this exemplary embodiment, the light-guide fixing device 47 is designed in the shape of a button with a groove along the circumference, wherein the dimensions are matched to the diameter of the light guide 2 in such a way that the light guide 2 can be inserted into the groove so that the light guide is clamped in the light-guide fixing device 47 and is held by it.

As visualized in FIG. 14, the light guide 2 can be held in place with the light-guide fixing device 47 and then wound around the hexagonal circumference of the positioning device 46 in a spiral manner. For this purpose, the light guide 2 is held under tension so that it is positioned closely to the previous spiral path or section of the light guide during winding and so that the light guide rests as firmly as possible on the surface of the positioning device 46, i.e., a projection of the light guide 2 from the positioning device 46 is prevented due to the stiffness of the light guide 2.

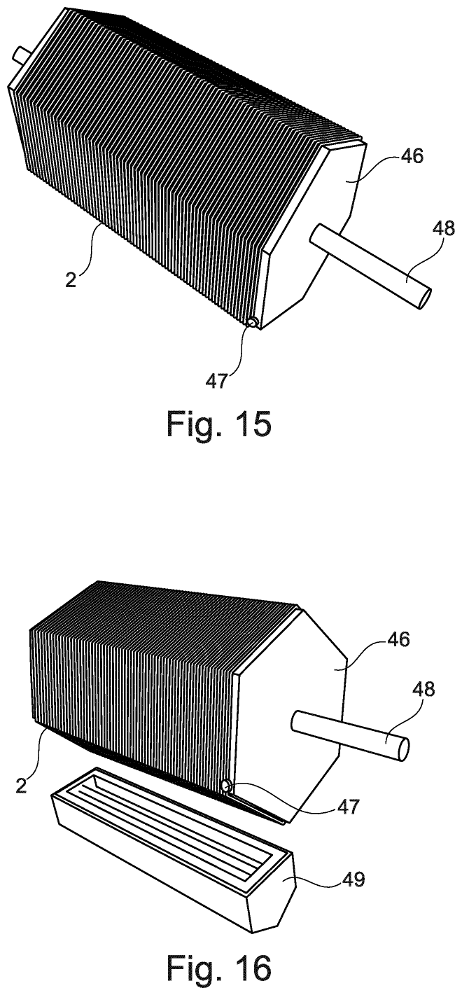

FIG. 15 shows the light guide 2 wound around the positioning device 46, wherein the positioning device is completely occupied.

As visualized in FIG. 16, the light guide 2 can now be subjected to heat treatment. For this purpose, a heat unit 49 is brought into the vicinity of the light guide 2 and the light guide 2 is heated to 50° C. for about 10 minutes. This reduces or removes the restoring forces in the light guide 2 and the light guide 2 assumes the shape applied to it by the positioning device 46, i.e., forms six straight (flat) sections along the six surfaces of the circumference of the positioning device 46. In heat treatment, the positioning device 46 is rotated either continuously or according to the surface segments with exposure pauses between the rotational movements.

Before, after or during heat treatment, the support elements 4 are now applied to the wound light guide 2. The support elements 4 are adhesive strips. In this case, the support elements 4 are placed in the middle of the flat lateral surfaces of the positioning device 46, i.e., between two corners of the cross-section of the positioning device 46. The support elements 4 are narrower than the lateral surfaces of the positioning device 46 so that areas of the light guide 2 remain free.

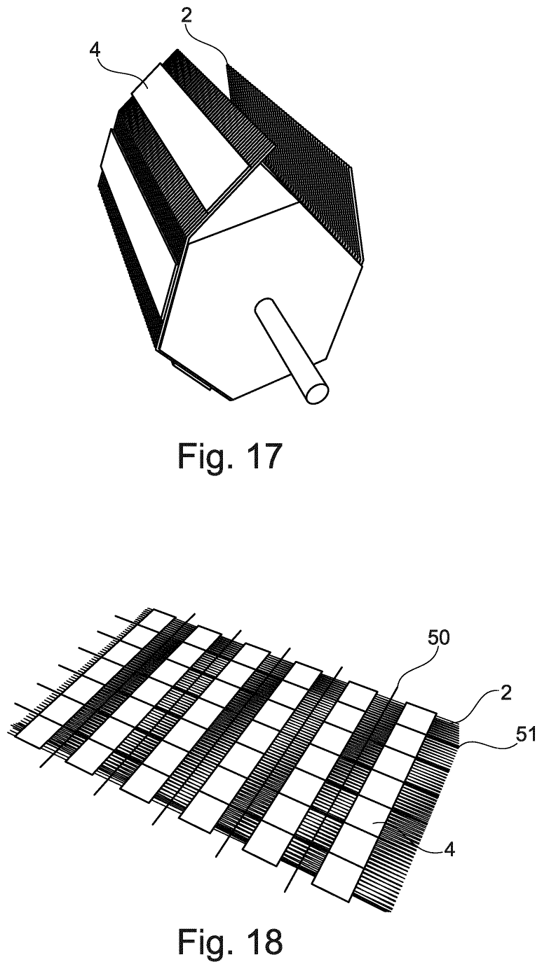

The light guide is then severed along one of the edges of the positioning device 46, as shown in FIG. 17.

The result is a two-dimensional structure consisting of a plurality of parallel light guides or light-guide sections 2, which are connected to each other by six support elements 4. In other words, it is an intermediate in the production of planar sensors 1, which are still related here.

FIG. 18 shows this intermediate product that has just been applied. Here, discontinuities 9 can now be introduced by grinding on the side of the light guide 2 that previously rested on the positioning device 46. However, these discontinuities 9 are only introduced in those areas of the light guide 2 that is held or fixed directly by the support elements 4. The free sections of light guide 2, i.e., those areas that are not contacted with support elements 4, remain free of discontinuities 9.

The intermediate product of light guides 2 and support elements 4 can now be further divided up to result in a plurality of planar sensors 1.

For this purpose, the light guides 2 are severed along five first section lines 50, wherein these first section lines 50 run along those areas of the light guide 2 that were previously placed at the edges of the positioning device 46. The first section lines 50 therefore run parallel to the support elements 4, each in the middle between two adjacent support elements 4.

Furthermore, the intermediate is severed along a multitude of second section lines 51. These second section lines 51 run parallel to the light guides 2, i.e., essentially at right angles to the stripe-like support elements 4. Along the second section lines 51, only the support elements 4 are severed but not the light guide 2.

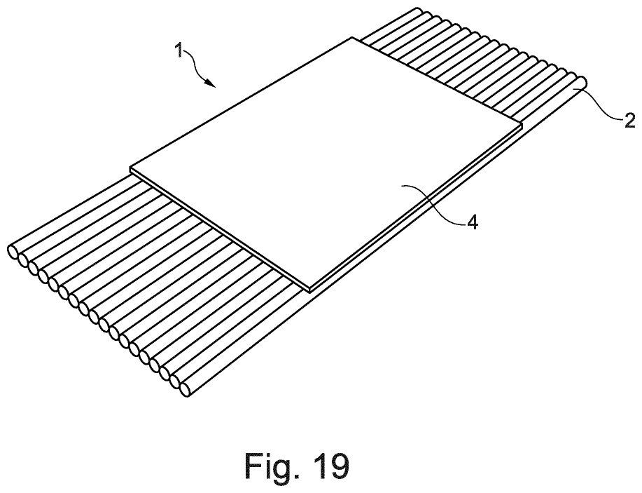

As shown in FIG. 19, after the separation of the intermediate product by cuts along the first and second section lines 51, 52, a plurality of isolated planar sensors 1 result. The free discontinuity-free end sections of the light guide 2 of the planar sensor 2 can now be bundled, as discussed earlier.

FIG. 20 shows another exemplary embodiment of a planar sensor 1, the basic structure of which correlates with the planar sensor 1 discussed earlier in connection with FIG. 2. Here, however, the diffusor layer 5 comprises a plurality of microlenses 5a. These microlenses 5a distribute an incoming light signal 8 to the light guides 2 below, so they serve to expand the light signal 8.

Furthermore, FIG. 20 provides the signal-emission layer or the feedback layer 52, which enables haptic feedback via the two vibration motors 31. In addition to the vibration motors 31, the feedback layer 52 comprises a portion of the feedback-signal channel 28 that is connected to the vibration motors 31 and is designed to power vibration motors 31. The feedback layer 51, as well as the vibration motors 31 and the feedback-signal channel 28 are flat. Similar to FIG. 2, FIG. 21 shows the planar sensor 1 in a three-dimensional view in an exploded image.

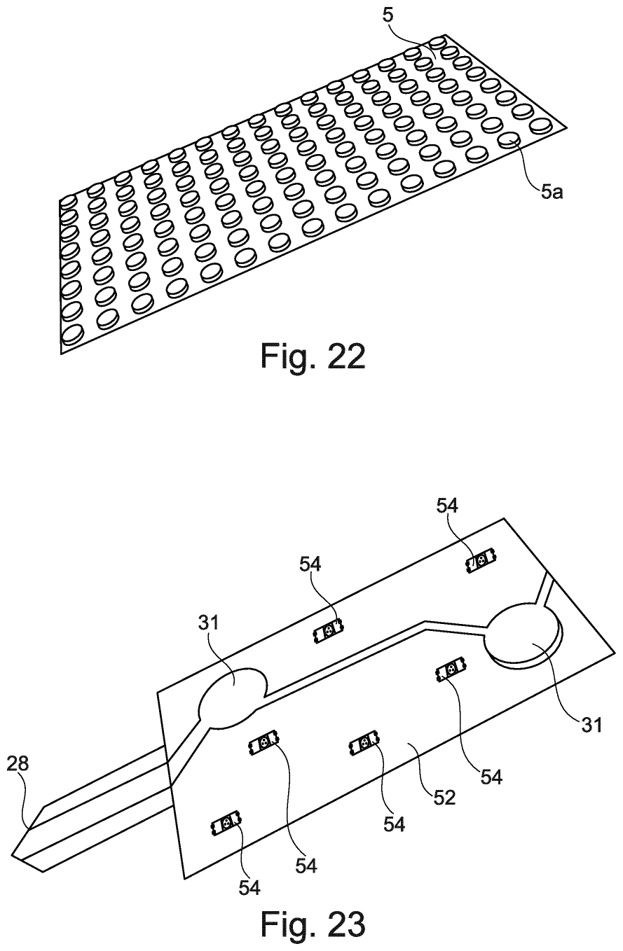

FIG. 22 shows only the diffuser layer 5 with the microlenses 5a.

FIG. 23 shows only the feedback layer 52, with the two vibration motors 31 and the feedback-signal channel 28 to which the vibration motors 31 are connected to be electronically controlled. The vibration motors 31 are positioned here at different positions of the feedback layer 52. FIG. 23 also shows RGB LEDs 54, which are distributed, preferably evenly distributed, on or in the plane of feedback layer 52. These RGB LEDs 54 are also electronically coupled to the feedback-signal channel 28 in a conventional way, which is not shown in detail, and can therefore be electronically controlled via the feedback-signal channel 28. With the aid of control by suitable control signals, light can be emitted at the desired intensity as well as color. The feedback layer 52 disclosed here can provide both optical and mechanical feedback, wherein the two types of feedback can also be used separately from each other. Each feedback element can be individually controlled via feedback-signal channel 28. The feedback channel 28 can therefore comprise a number of control lines corresponding to the feedback elements or also a number of control lines corresponding to the different types of feedback.

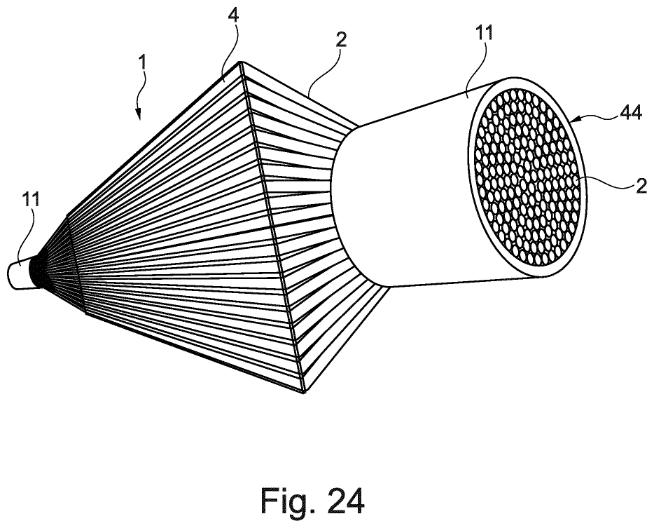

FIG. 24 shows a further exemplary embodiment of the planar sensor 1, wherein the light guides 2 each comprise two free end sections, namely to the left and to the right side of the support element 4, and the light guide tufts of the end sections are each held in a separate sleeve 11. Each of the sleeves 11 can be connected to a separate reception detector 13, which improves the signal yield compared to the use of only one reception detector 13 and thus ensures reliable signal detection even with weak light signals 8.

Ultimately, it is pointed out once again that the figures described in detail above are only exemplary embodiments, which can be modified by the person skilled in the art in various ways without leaving the scope of the invention. For the sake of completeness, it is also pointed out that the use of the indefinite article “a” does not exclude that the respective features can also be present a multiple of times.

1. A planar sensor (1), in particular, a flexible planar sensor (1), which comprises,
at least one light guide (2) which comprises discontinuities (9) along its longitudinal extension on its side intended for light entry in order to enable the detection or entry of a light signal (8), and
a support element (4), which supports the light guide (2) on one side, preferred in such a way that the discontinuities (9) of the light guide (2) are oriented away from the support element (4).

2. The planar sensor (1) according to claim 1, wherein, along the side of the light guide (2) not intended for light entry, there are essentially no discontinuities.

3. The planar sensor (1) according to claim 1, wherein light-guide sections of at least one light guide (2) or a plurality of light guides (2) are positioned directly next to each other, in particular, adjacent to each other, on the support element (4).

4. The planar sensor (1) according to claim 1, wherein at least one light guide (2) is bonded to the support element (4) in a substance-to-substance manner.

5. The planar sensor (1) according to claim 1, which comprises a diffuser layer (5), in particular, upstream in the direction of the light entry, in particular, comprising microlenses.

6. The planar sensor (1) according to claim 1, comprising a signal-emission layer (52) which is designed for emitting an emission signal that can be optically generated and/or mechanically generated.

7. A manufacturing method for the manufacture of a planar sensor (1), wherein at least one light guide (2) is fixed on one side of a support element (4), preferably fixed in a substance-to-substance manner, and being particularly preferred, it is glued.

8. The manufacturing method according to claim 7, wherein at least one light guide (2) is applied to a positioning device (46), preferably wound onto it.

9. The manufacturing method according to claim 8, wherein the light guide (2) applied to the positioning device (46) is subjected to heat treatment, preferably with a temperature in the range of 60° C. to 80° C., being particularly preferred, with about 70° C., in particular, hot air treatment.

10. The manufacturing method according to claim 7, wherein the light guide (2) applied to the positioning device (46) is severed along at least one line, at a distance from the support element (4).

11. The manufacturing method according to claim 7, wherein after fixing the light guide (2) on the support element (4), discontinuities (9) are introduced into the light guide (2), in particular, on the side of the light guide (2) facing away from the support element (4).

12. A planar-sensor module (12), which comprises
a planar sensor (1) according to claim 1, and
at least one reception detector (13) coupled to the planar sensor, which is designed to convert and emit a light signal (8) which has entered the planar sensor (1) into an analog or digital electrical reception signal (18).

13. The planar-sensor module (12) according to claim 12, wherein the reception detector (13) encloses the light guide (2) or the light guides (2) in a sleeve-shaped manner at the end.

14. A planar-sensor group (19A-19E), which comprises
at least one planar-sensor module (12) according to claim 12, and
a processing module (20) coupled with at least one planar-sensor module (12), which is designed to process the reception signal (18) of at least one planar-sensor module (12), preferably captures the data content thereby represented.

15. The planar-sensor group (19A-19E) according to claim 14, which is designed to provide or emit a data representation of the processed reception signal (18).

16. The planar-sensor group (19A-19E) according to claim 14,
wherein at least one planar sensor (1) comprising a signal-emission layer (52) which is designed for emitting an emission signal that can be optically generated and/or mechanically generated is provided, and
wherein the planar-sensor group (19A-19E), preferably the processing module (20), comprises a feedback stage (23) which is designed to control the signal-emission layer (52) of the planar sensor (1) as a result of an occurrence of the reception signal (18).

17. A system (42), which comprises:
at least one planar-sensor group (19A-19E) according to claim 14, and
a central module (22) coupled with at least one planar-sensor group (19A-19E).

18. The system (42) according to claim 17, wherein the central module is designed for autonomous processing of the data content acquired by means of the processing step (20) of the planar-sensor group (19A-19E) for the purpose of determining a realistically expected effect of the event represented or simulated by the light signal, in particular, by comparing with a medical database stored in the system for the purpose of defining or retrieving a realistic injury pattern, and wherein the system is designed for the automatic integration of a line of care, in particular, a medical one, on the basis of the autonomously determined, realistically expected effect of the event represented or simulated by the light signal.

19. The system (42) according to claim 17, which is designed for autonomous processing of the data content acquired by means of the processing stage (20) of the planar-sensor group (19A-19E) and for generating a control signal.

20. The system (42) according to claim 19, comprising:
a signal-emission device (33) which can be attached to a weapon, in particular a firearm, preferably without obstructing the firing of the weapon, and
wherein the signal-emission device (33) is designed to emit the light signal (8) corresponding to the firing of the weapon.

21. The system (42) according to claim 20, wherein
the signal-emission device (33) comprises an acceleration sensor for detecting acceleration, preferably also an acoustic sensor for detecting a sound event, and
the signal-emission device (33) is designed to detect the firing of a weapon to which the signal-emission device is attached, taking into account an acceleration detected by the acceleration sensor, preferably taking into account the sound event detected, and
the signal-emission device (33) is designed to emit the light signal (8) automatically as a result of the detection of the firing of the weapon.

22. The system (42) according to claim 20, wherein the signal-emission device (33) is designed to receive the control signal and to influence its range of functions depending on the control signal.

23. The system (42) according to claim 22,
wherein the influence on the range of functions concerns the ability to emit the light signal.

24. A combat or sports or gaming or track suit (35), which at least comprises:
a planar-sensor module (12) according to claim 12.

25. A device or component cover comprising at least one planar-sensor module (12) according to claim 12.
